(19) United States
(12) Patent Application Publication
(10) Pub. No.: US 2026/0260078 A1
(43) Pub. Date: Sep. 3, 2026

(54) INFORMATION PROCESSING SYSTEM AND INFORMATION PROCESSING METHOD

(71) Applicant: SEMICONDUCTOR ENERGY LABORATORY CO., LTD., Atsugi-shi (JP)

(72) Inventors: Junpei MOMO, Sagamihara (JP); Natsuko TAKASE, Isehara (JP); Shunpei YAMAZAKI, Tokyo (JP)

(21) Appl. No.: 19/545,111

(22) Filed: Feb. 20, 2026

(30) Foreign Application Priority Data
Feb. 28, 2025 (JP) 2025-030999

(51) Int. Cl. G06F 40/40; G06F 40/166

(52) U.S. Cl. CPC G06F 40/40; G06F 40/166

(57) ABSTRACT

An information processing system comprising three components is provided. The first component receives a document and a target, transmits the document and the target to the third component, and receives and provides an embodiment draft. The second component receives a prompt and generates a composition and the embodiment draft using a large language model. The third component receives and shares the document, the target, and the composition, and receives the embodiment draft, and transmits the embodiment draft to the first component. The third component also includes a subcomponent for creating and executing a prompt chain. The system proposes the composition not described in the document, proposes the composition relevant to the target, and generates the embodiment draft on the basis of the composition. A user can implement the composition in accordance with the proposal or the embodiment draft and confirm the effect of the composition.

### BACKGROUND OF THE INVENTION

### 1. Field of the Invention

One embodiment of the present invention relates to an information processing system, an information processing method, or a semiconductor device.

Note that one embodiment of the present invention is not limited to the above technical field. The technical field of one embodiment of the invention disclosed in this specification and the like relates to an object, a method, or a manufacturing method. In addition, one embodiment of the present invention relates to a process, a machine, manufacture, or a composition of matter. Thus, more specifically, examples of the technical field of one embodiment of the present invention disclosed in this specification include an information processing device, a semiconductor device, a memory device, a driving method thereof, and a manufacturing method thereof.

### 2. Description of the Related Art

In recent years, language models using neural networks have been actively developed, and especially large language models (LLM) have attracted attention. A large language model is a natural language processing model trained on a large amount of data. With a large language model, for example, a communication model that gives an answer to a user's instruction can be achieved. In Non-Patent Document 1, generative pre-trained transformer 4 (GPT-4, registered trademark) is disclosed as a large language model, and ChatGPT (registered trademark) is disclosed as a communication model.

By utilizing a large language model, the capability of a natural language processing model has been significantly increased. On the other hand, owing to the expansion of the language model, it is difficult to incorporate and operate a language model on one's own from the aspect of facilities and costs. Accordingly, utilizing an external service that provides a language model is one of the utility forms of a language model.

### Reference

### Non-Patent Document

Non-Patent Document 1 Summary of ChatGPT/GPT-4 Research and Perspective Towards the Future of Large Language Models, Yiheng Liu et al., (submitted on 4 April, 2023) [online], Internet URL: https://arxiv.org/abs/2304.01852

### SUMMARY OF THE INVENTION

One object of one embodiment of the present invention is to provide a novel information processing system that is highly convenient, useful, or reliable. Another object of one embodiment of the present invention is to provide a novel information processing method that is highly convenient, useful, or reliable. Another object of one embodiment of the present invention is to provide a novel information processing system, a novel information processing method, or a novel semiconductor device.

Note that the description of these objects does not preclude the presence of other objects. One embodiment of the present invention does not need to achieve all these objects. Other objects will be apparent from and can be derived from the description of the specification, the drawings, the claims, and the like.

(1) An information processing system of one embodiment of the present invention has a function of receiving a document and a target, a function of providing an embodiment draft, and a function of executing processing using a large language model. The document includes technical information relevant to the target, and the large language model has a function of generating a first composition in accordance with a first prompt and a function of generating the embodiment draft in accordance with a second prompt.

The first prompt includes a first instruction, the document, and the target. The first instruction includes a procedure for making the large language model propose the first composition with reference to the document. The first composition is a composition that is not described in the document and is relevant to the target.

The second prompt includes a second instruction and the first composition, and the second instruction includes a procedure for making the large language model generate the embodiment draft on the basis of the first composition.

(2) One embodiment of the present invention is an information processing system including a first component, a second component, and a third component.

The first component has a function of receiving a document and a target and transmitting the document and the target to the third component and a function of receiving an embodiment draft and providing the embodiment draft. Note that the document includes technical information relevant to the target.

The second component has a function of receiving a first prompt and a second prompt and transmitting a first composition and the embodiment draft to the third component, and a function of executing processing using a large language model. The large language model has a function of generating the first composition in accordance with the first prompt and a function of generating the embodiment draft in accordance with the second prompt.

The third component has a function of receiving and internally sharing the document, the target, and the first composition, a function of transmitting the first prompt and the second prompt to the second component, and a function of receiving the embodiment draft and transmitting the embodiment draft to the first component. The third component includes a first subcomponent.

The first subcomponent has a function of creating and executing a first prompt chain, and the first prompt chain includes the first prompt and the second prompt.

The first prompt includes a first instruction, the document, and the target, and the first instruction includes a procedure for making the large language model propose the first composition with reference to the document. The first composition is a composition that is not described in the document, and the first composition is relevant to the target.

The second prompt includes a second instruction and the first composition, and the second instruction includes a procedure for making the large language model generate the embodiment draft on the basis of the first composition.

In this manner, the first composition that is not described in the document can be proposed. In addition, the first composition relevant to the target can be proposed. The embodiment draft can be generated on the basis of the first composition. For example, a user of the information processing system can implement the first composition in accordance with the embodiment draft. For example, the user of the information processing system can confirm the effect of the first composition. Thus, a novel information processing system that is highly convenient, useful, or reliable can be provided. Note that examples of the embodiment draft in this specification and the like include drafts of an embodiment, an embodiment mode, and an example.

(3) One embodiment of the present invention is the information processing system where the first component includes a function of receiving an adjustment request and transmitting the adjustment request to the third component. Note that the adjustment request is a request for adjustment of the embodiment draft.

The second component has a function of receiving a third prompt and transmitting a new embodiment draft to the third component. The large language model has a function of generating the new embodiment draft in accordance with the third prompt.

The third component has a function of receiving and internally sharing the adjustment request.

The first subcomponent has a function of creating the third prompt. The third prompt includes a third instruction, the embodiment draft, and the adjustment request, and the third instruction includes a procedure for making the large language model adjust the embodiment draft on the basis of the adjustment request.

In this manner, for example, a user of the information processing system can request adjustment of the embodiment draft. The information processing system of one embodiment of the present invention can adjust the embodiment draft on the basis of the request. For example, the user of the information processing system can request adjustment of the proposed first composition. The information processing system of one embodiment of the present invention can adjust the first composition on the basis of the request. Thus, a novel information processing system that is highly convenient, useful, or reliable can be provided.

(4) One embodiment of the present invention is the information processing system wherein the first component has a function of receiving and providing a comparative example.

The second component has a function of receiving a fourth prompt and a fifth prompt and transmitting a second composition and the comparative example to the third component. The large language model has a function of generating the second composition in accordance with the fourth prompt and a function of generating the comparative example in accordance with the fifth prompt.

The third component has a function of receiving the comparative example and transmitting the comparative example to the first component.

The first subcomponent has a function of creating and executing a second prompt chain, and the second prompt chain includes the fourth prompt and the fifth prompt.

The fourth prompt includes a fourth instruction, the document, and the target, and the fourth instruction includes a procedure for making the large language model propose the second composition with reference to the document. The second composition is a composition described in the document, and is relevant to the target.

The fifth prompt includes a fifth instruction and the second composition, and the fifth instruction includes a procedure for making the large language model generate the comparative example on the basis of the second composition.

In this manner, the second composition described in the document can be proposed. In addition, the second composition relevant to the target can be proposed. A comparative example can be generated on the basis of the second composition. For example, a user of the information processing system can implement the second composition in accordance with the comparative example. For example, the user of the information processing system can confirm the effect of the second composition. Thus, a novel information processing system that is highly convenient, useful, or reliable can be provided.

(5) One embodiment of the present invention is the information processing system wherein the first component has a function of receiving an evaluation and transmitting the evaluation to the third component and a function of receiving and providing an embodiment. The evaluation is an evaluation result of an effect of the first composition.

The second component has a function of receiving a sixth prompt and transmitting the embodiment to the third component. The large language model has a function of generating the embodiment in accordance with the sixth prompt.

The third component has a function of receiving and internally sharing the evaluation, and a function of receiving the embodiment and transmitting the embodiment to the first component. The first subcomponent has a function of creating the sixth prompt.

The sixth prompt includes a sixth instruction, the embodiment draft, and the evaluation, and the sixth instruction includes a procedure for making the large language model generate the embodiment on the basis of the embodiment draft and the evaluation.

In this manner, the embodiment can be generated by adding the evaluation to the embodiment draft. The first composition that is not described in the document and the evaluation of the first composition can be described in the embodiment. Moreover, a significant effect of the first composition can be described in the embodiment on the basis of the evaluation. In addition, the action of the first composition can be described in the embodiment. Thus, a novel information processing system that is highly convenient, useful, or reliable can be provided.

(6) One embodiment of the present invention is the information processing system wherein the first component has a function of receiving a title of an invention and the target and transmitting the title of the invention and the target to the third component, and a function of receiving and providing the document.

The second component has a function of receiving a seventh prompt and transmitting the document to the third component. The large language model has a function of selecting the document from a search result in accordance with the seventh prompt.

The third component has a function of receiving and internally sharing the title of the invention and the target and a function of receiving the document and transmitting the document to the first component. The third component includes a second subcomponent.

The second subcomponent includes a database and a management system. The database stores technical literature, and the management system has a function of generating the search result in accordance with a query.

The first subcomponent has a function of creating the query and the seventh prompt. The query includes a request to collect literature relevant to the title of the invention and the target from the database as the search result.

The seventh prompt includes a seventh instruction, the search result, and the target, and the seventh instruction includes a procedure for making the large language model select an appropriate document relevant to the target on the basis of the search result.

In this manner, literature relevant to the title of the invention and the target can be collected from the database as the search result. An appropriate document relevant to the target can be selected from the search result. Thus, a novel information processing system that is highly convenient, useful, or reliable can be provided.

(7) One embodiment of the present invention is an information processing method including first to eleventh steps.

In the first step, a first component receives a document and a target and transmits the document and the target to a second component. The document includes technical information relevant to the target.

In the second step, the second component receives and internally shares the document and the target. The second component includes a first subcomponent, and the first subcomponent has a function of creating and executing a first prompt chain. The first prompt chain includes a first prompt and a second prompt.

In the third step, the second component transmits the first prompt to a third component. The first prompt includes a first instruction, the document, and the target. The first instruction includes a procedure for making a large language model propose a first composition with reference to the document. The first composition is a composition that is not described in the document and is relevant to the target.

In the fourth step, the third component receives the first prompt and generates the first composition using the large language model.

In the fifth step, the third component transmits the first composition to the second component.

In the sixth step, the second component receives and internally shares the first composition.

In the seventh step, the second component transmits the second prompt to the third component. The second prompt includes a second instruction and the first composition, and the second instruction includes a procedure for making the large language model generate an embodiment draft on the basis of the first composition.

In the eighth step, the third component receives the second prompt and generates the embodiment draft using the large language model.

In the ninth step, the third component transmits the embodiment draft to the second component.

In the tenth step, the second component receives the embodiment draft and transmits the embodiment draft to the first component.

In the eleventh step, the first component receives and provides the embodiment draft.

In this manner, the first composition that is not described in the document can be proposed. In addition, the first composition relevant to the target can be proposed. The embodiment draft can be generated on the basis of the first composition. For example, a user of the information processing system can implement the first composition in accordance with the embodiment draft. For example, the user of the information processing system can confirm the effect of the first composition. Thus, a novel information processing method that is highly convenient, useful, or reliable can be provided.

(8) One embodiment of the present invention is the information processing method including twelfth to eighteenth steps.

In the twelfth step, the first component receives an adjustment request and transmits the adjustment request to the second component.

In the thirteenth step, the second component receives and internally shares the adjustment request. The first subcomponent has a function of creating a third prompt.

In the fourteenth step, the second component transmits the third prompt to the third component. The third prompt includes a third instruction, the embodiment draft, and the adjustment request. The third instruction includes a procedure for making the large language model adjust the embodiment draft on the basis of the adjustment request.

In the fifteenth step, the third component receives the third prompt and adjusts the embodiment draft using the large language model.

In the sixteenth step, the third component transmits the embodiment draft to the second component.

In the seventeenth step, the second component transmits the embodiment draft to the first component.

In the eighteenth step, the first component receives and provides the embodiment draft.

In this manner, for example, a user of the information processing system can request adjustment of the embodiment draft. The information processing system of one embodiment of the present invention can adjust the embodiment draft on the basis of the request. For example, the user of the information processing system can request adjustment of the proposed first composition. The information processing system of one embodiment of the present invention can adjust the first composition on the basis of the request. Thus, a novel information processing method that is highly convenient, useful, or reliable can be provided.

(9) One embodiment of the present invention is the information processing method including nineteenth to twenty-fifth steps.

In the nineteenth step, the first component receives an evaluation and transmits the evaluation to the second component.

In the twentieth step, the second component receives and internally shares the evaluation. The first subcomponent has a function of creating a fourth prompt.

In the twenty-first step, the second component transmits the fourth prompt to the third component. The fourth prompt includes a fourth instruction, the embodiment draft, and the evaluation. The fourth instruction includes a procedure for making the large language model generate an embodiment on the basis of the embodiment draft and the evaluation.

In the twenty-second step, the third component receives the fourth prompt and generates the embodiment using the large language model.

In the twenty-third step, the third component transmits the embodiment to the second component.

In the twenty-fourth step, the second component receives the embodiment and transmits the embodiment to the first component.

In the twenty-fifth step, the first component receives and provides the embodiment.

In this manner, the embodiment can be generated by adding the evaluation to the embodiment draft. The first composition that is not described in the document and the evaluation of the first composition can be described in the embodiment. Moreover, a significant effect of the first composition can be described in the embodiment on the basis of the evaluation. In addition, the action of the first composition can be described in the embodiment. Thus, a novel information processing method that is highly convenient, useful, or reliable can be provided.

(10) One embodiment of the present invention is the information processing method including twenty-sixth to thirty-fourth steps. The first subcomponent has a function of creating and executing a second prompt chain. The second prompt chain includes a fifth prompt and a sixth prompt.

In the twenty-sixth step, the second component transmits the fifth prompt to the third component. The fifth prompt includes a fifth instruction, the document, and the target, and the fifth instruction includes a procedure for making the large language model propose a second composition with reference to the document. The second composition is a composition described in the document, and is relevant to the target.

In the twenty-seventh step, the third component receives the fifth prompt and generates the second composition using the large language model.

In the twenty-eighth step, the third component transmits the second composition to the second component.

In the twenty-ninth step, the second component receives and internally shares the second composition.

In the thirtieth step, the second component transmits the sixth prompt to the third component. The sixth prompt includes a sixth instruction and the second composition. The sixth instruction includes a procedure for making the large language model generate a comparative example on the basis of the second composition.

In the thirty-first step, the third component receives the sixth prompt and generates the comparative example using the large language model.

In the thirty-second step, the third component transmits the comparative example to the second component.

In the thirty-third step, the second component receives the comparative example and transmits the comparative example to the first component.

In the thirty-fourth step, the first component receives and provides the comparative example.

In this manner, the second composition described in the document can be proposed. In addition, the second composition relevant to the target can be proposed. A comparative example can be generated on the basis of the second composition. For example, a user of the information processing system can implement the second composition in accordance with the comparative example. For example, the user of the information processing system can confirm the effect of the second composition. Thus, a novel information processing method that is highly convenient, useful, or reliable can be provided.

(11) One embodiment of the present invention is the information processing method including first to tenth pre-processing steps.

In the first pre-processing step, the first component receives a title of an invention and the target and transmits the title of the invention and the target to the second component.

In the second pre-processing step, the second component receives and internally shares the title of the invention and the target. The second component includes the first subcomponent and a second subcomponent. The second subcomponent includes a database and a management system. The database stores technical literature.

In the third pre-processing step, the first subcomponent creates a query. The query includes a request to collect literature relevant to the title of the invention and the target from the database as a search result.

In the fourth pre-processing step, the management system generate the search result in accordance with the query.

In the fifth pre-processing step, the first subcomponent creates a seventh prompt. The seventh prompt includes a seventh instruction, the search result, and the target. The seventh instruction includes a procedure for making the large language model select an appropriate document relevant to the target on the basis of the search result.

In the sixth pre-processing step, the second component transmits the seventh prompt to the third component.

In the seventh pre-processing step, the third component receives the seventh prompt and generates the document using the large language model.

In the eighth pre-processing step, the third component transmits the document to the second component.

In the ninth pre-processing step, the second component receives the document and transmits the document to the first component.

In the tenth pre-processing step, the first component receives the document and executes the first step.

In this manner, literature relevant to the title of the invention and the target can be collected from the database as the search result. An appropriate document relevant to the target can be selected from the search result. Thus, a novel information processing method that is highly convenient, useful, or reliable can be provided.

One embodiment of the present invention can provide a novel information processing system that is highly convenient, useful, or reliable. Another embodiment of the present invention can provide a novel information processing method that is highly convenient, useful, or reliable. Another embodiment of the present invention can provide a novel information processing system, a novel information processing method, or a novel semiconductor device.

Note that the description of these effects does not preclude the presence of other effects. One embodiment of the present invention does not necessarily have all these effects. Other effects will be apparent from and can be derived from the description of the specification, the drawings, the claims, and the like.

### BRIEF DESCRIPTION OF THE DRAWINGS

In the accompanying drawings:

FIG. 1 illustrates information processing system architecture according to an embodiment;

FIG. 2 illustrates information processing system architecture according to an embodiment;

FIG. 3 illustrates a structure of a component used in an information processing system according to an embodiment;

FIGS. 4A to 4C each illustrate a structure of a prompt used in an information processing system according to an embodiment;

FIG. 5 illustrates a structure of a prompt used in an information processing system according to an embodiment;

FIGS. 6A to 6C each illustrate a structure of a prompt used in an information processing system according to an embodiment;

FIG. 7 illustrates a structure of a prompt used in an information processing system according to an embodiment;

FIG. 8 illustrates information processing system architecture according to an embodiment;

FIG. 9 illustrates a structure of a component used in an information processing system according to an embodiment;

FIG. 10 illustrates a structure of a prompt used in an information processing system according to an embodiment;

FIG. 11 illustrates a structure of an information processing device used for an information processing system according to an embodiment;

FIG. 12 illustrates an information processing method according to an embodiment;

FIG. 13 illustrates an information processing method according to an embodiment;

FIG. 14 illustrates an information processing method according to an embodiment;

FIG. 15 illustrates an information processing method according to an embodiment; and

FIG. 16 illustrates an information processing method according to an embodiment.

### DETAILED DESCRIPTION OF THE INVENTION

An information processing system of one embodiment of the present invention includes a first component, a second component, and a third component.

The first component has a function of receiving a document and a target and transmitting the document and the target to the third component and a function of receiving an embodiment draft and providing the embodiment draft. Note that the document includes technical information relevant to a target.

The second component has a function of receiving a first prompt and a second prompt, transmitting a first composition and the embodiment draft to the third component, and a function of executing processing using a large language model. The large language model has a function of generating the first composition in accordance with the first prompt and a function of generating the embodiment draft in accordance with the second prompt.

The third component has a function of receiving and internally sharing the document, the target, and the first composition, and a function of receiving the embodiment draft and transmitting the embodiment draft to the first component. The third component includes a first subcomponent.

The first subcomponent has a function of creating and executing a first prompt chain, and the first prompt chain includes the first prompt and the second prompt. The first prompt includes a first instruction, a document, and a target, and the first instruction includes a procedure for making the large language model propose the first composition with reference to the document. Note that the first composition is a composition not described in the document, and the first composition is relevant to the target. The second prompt includes a second instruction and the first composition, and the second instruction includes a procedure for making the large language model generate an embodiment draft on the basis of the first composition.

In this manner, the first composition that is not described in the document can be proposed. In addition, the first composition relevant to the target can be proposed. The embodiment draft can be generated on the basis of the first composition. For example, a user of the information processing system can implement the first composition in accordance with the embodiment draft. For example, the user of the information processing system can confirm the effect of the first composition. Thus, a novel information processing system that is highly convenient, useful, or reliable can be provided.

Embodiments will be described in detail with reference to the drawings. Note that the present invention is not limited to the following description, and it will be readily appreciated by those skilled in the art that modes and details of the present invention can be modified in various ways without departing from the spirit and scope of the present invention. Thus, the present invention should not be construed as being limited to the description in the following embodiments. Note that in structures of the invention described below, the same portions or portions having similar functions are denoted by the same reference numeral in different drawings, and the description thereof is not repeated.

Ordinal numbers such as "first" and "second" in this specification and the like are used in order to avoid confusion among components. Thus, the terms do not limit the number of components or the order of components (e.g., the order of steps or the stacking order of layers). A term without an ordinal number in this specification and the like may be described with an ordinal number in a claim in order to avoid confusion among components. A term with an ordinal number in this specification and the like may be described with a different ordinal number in a claim. A term with an ordinal number in this specification and the like may be described without an ordinal number in a claim.

Although a block diagram in which components are classified by their functions and shown as independent blocks is shown in the drawing attached to this specification, it is difficult to completely separate actual components according to their functions and one component can relate to a plurality of functions.

### Embodiment 1

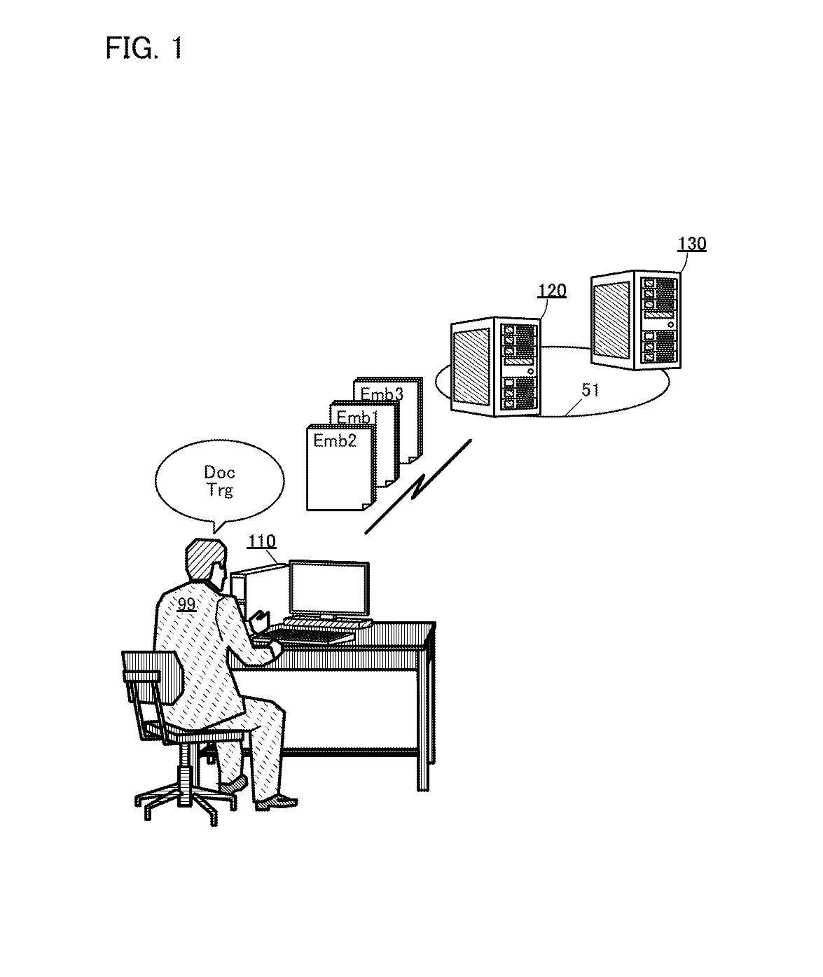

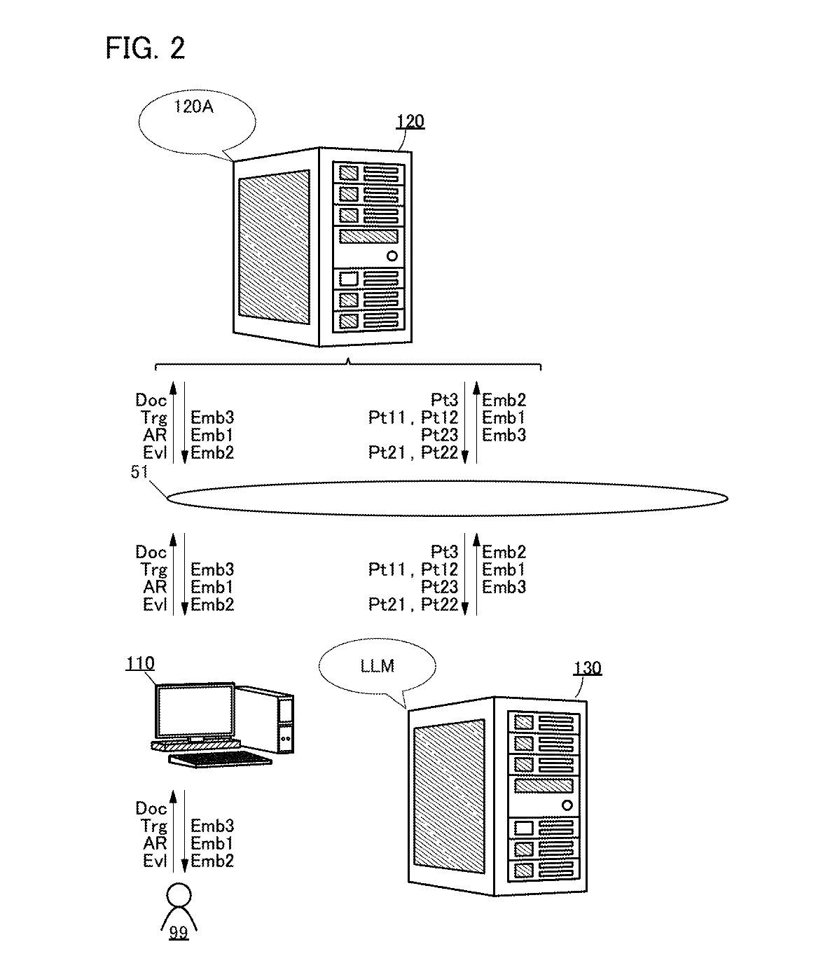

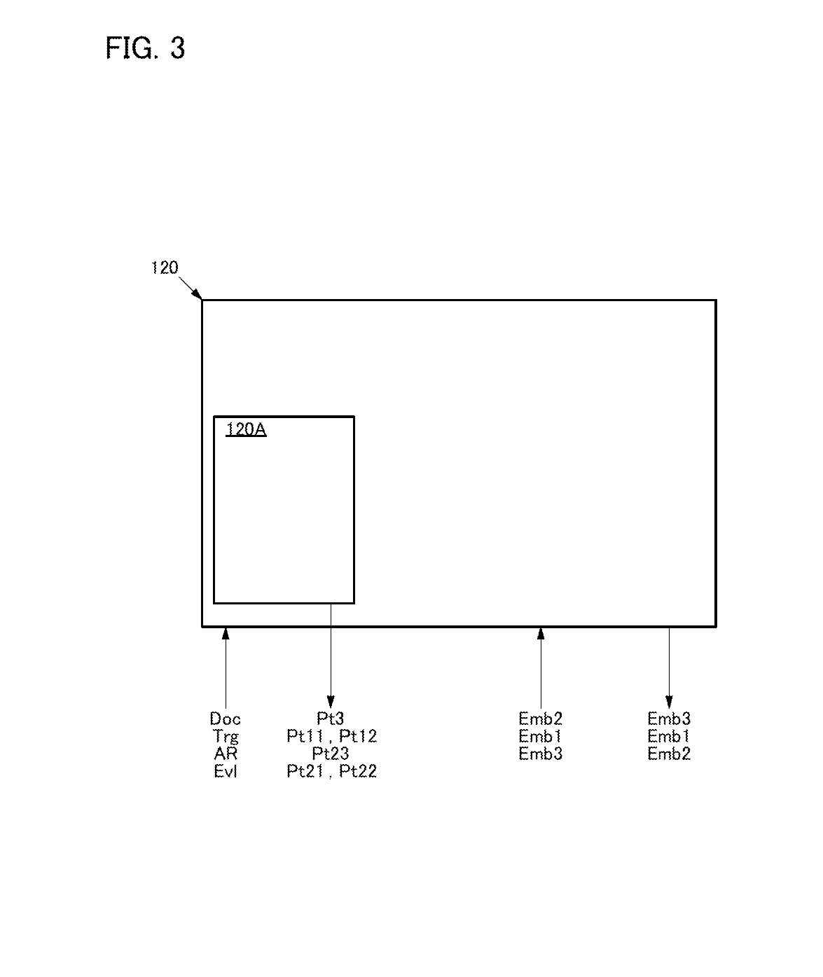

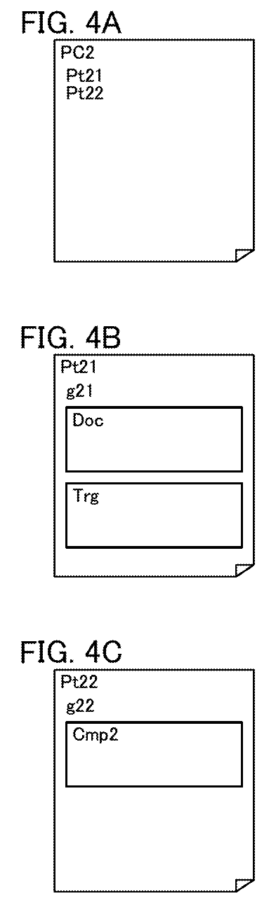

In this embodiment, an information processing system of one embodiment of the present invention will be described with reference to FIG. 1, FIG. 2, FIG. 3, FIGS. 4A to 4C, FIG. 5, FIGS. 6A to 6C, FIG. 7, FIG. 8, FIG. 9, FIG. 10, and FIG. 11.

FIG. 1 and FIG. 2 illustrate information processing system architecture of one embodiment of the present invention.

FIG. 3 illustrates a structure of a component used in the information processing system of one embodiment of the present invention.

FIG. 4A is a diagram illustrating a structure of a prompt chain used in the information processing system of one embodiment of the present invention, and FIGS. 4B and 4C are diagrams each illustrating a structure of a prompt received and transmitted internally in the information processing system.

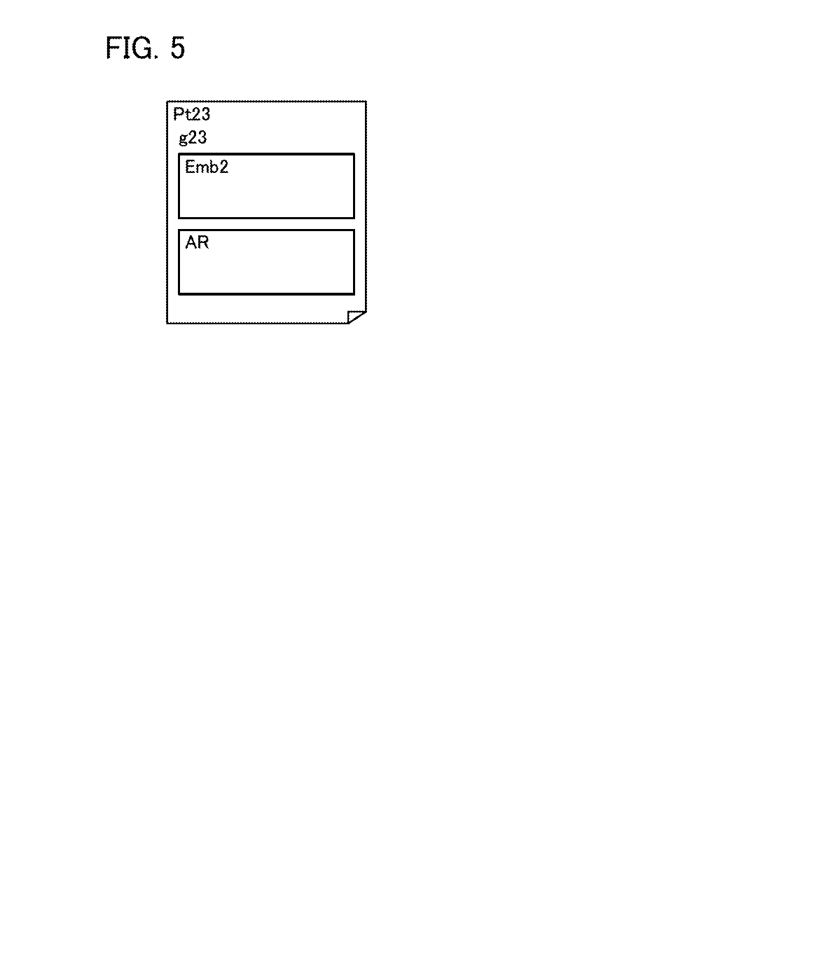

FIG. 5 illustrates a structure of a prompt that is transmitted and received internally in the information processing system of one embodiment of the present invention.

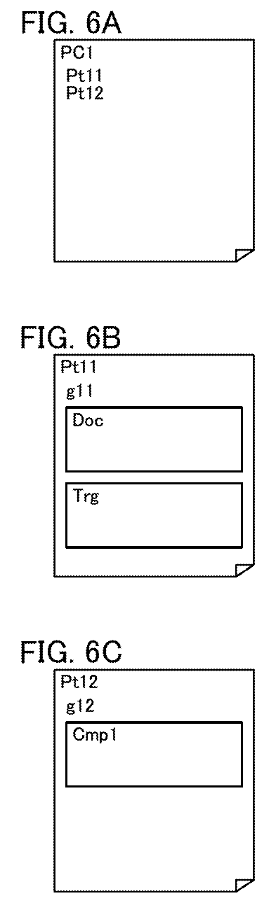

FIG. 6A is a diagram illustrating a structure of a prompt chain used in the information processing system of one embodiment of the present invention, and FIGS. 6B and 6C are diagrams each illustrating a structure of a prompt transmitted and received internally in the information processing system.

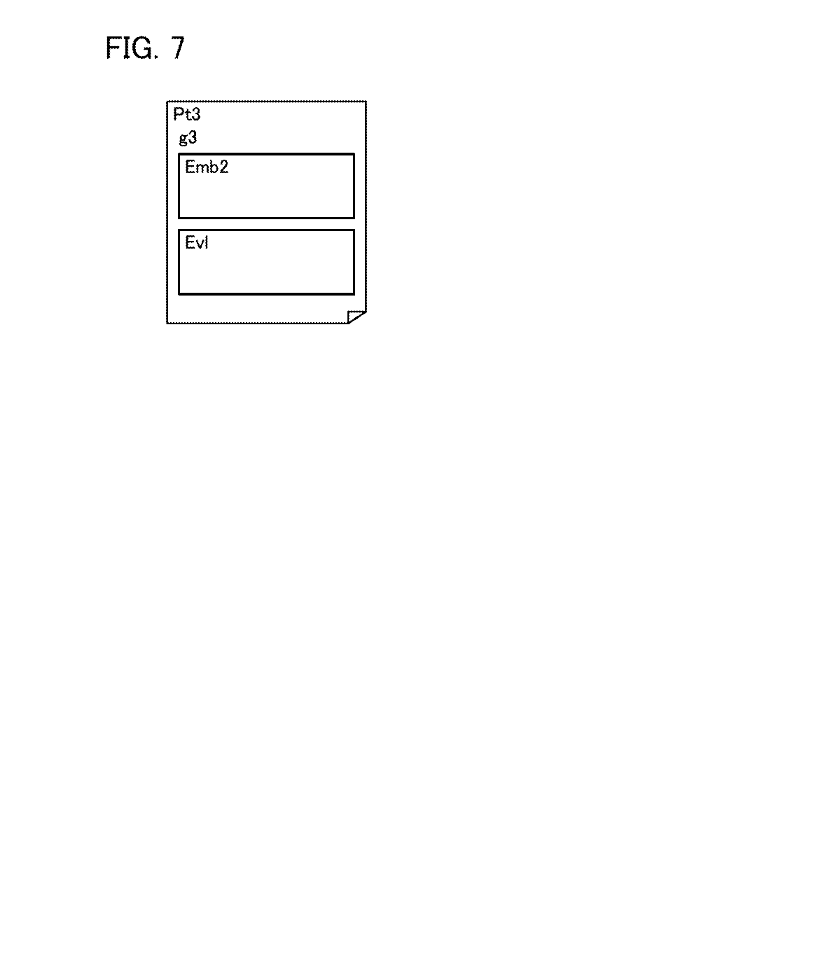

FIG. 7 is a diagram illustrating a structure of a prompt transmitted and received internally in the information processing system of one embodiment of the present invention.

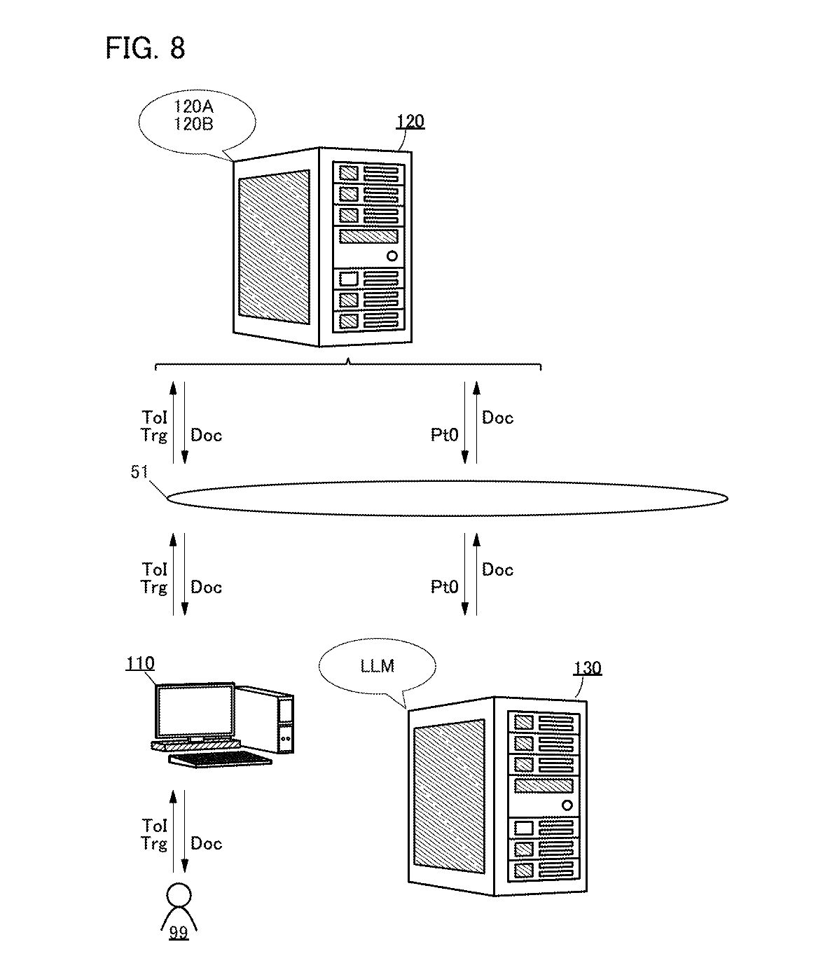

FIG. 8 is a diagram illustrating information processing system architecture of one embodiment of the present invention.

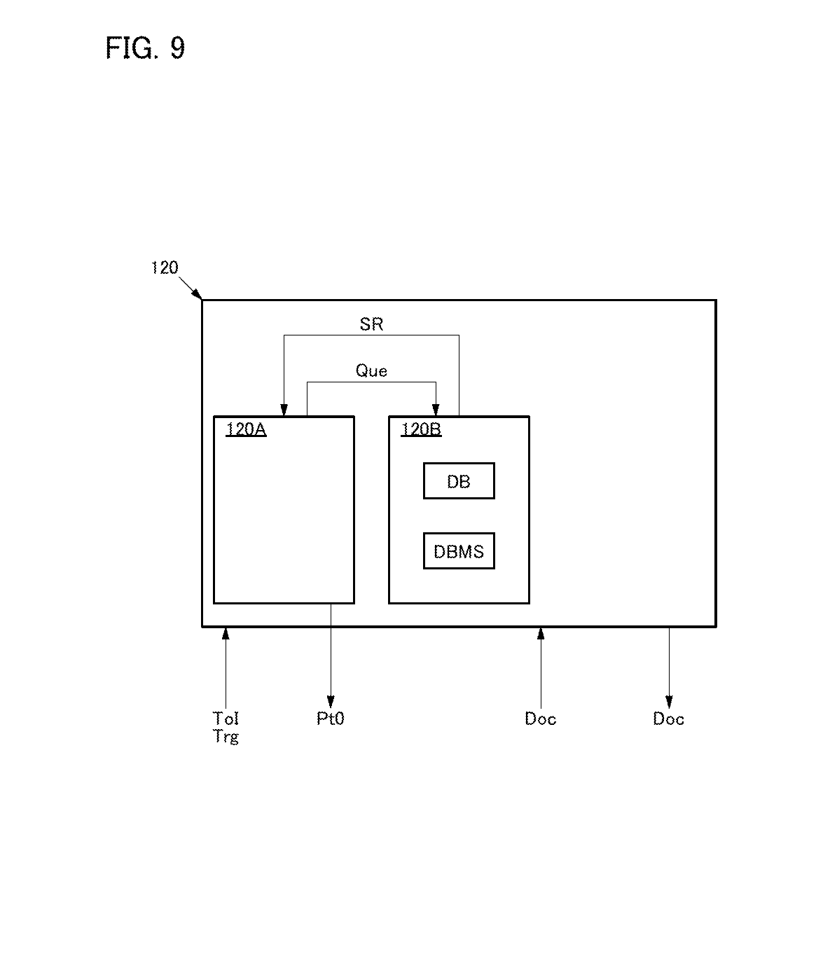

FIG. 9 is a diagram illustrating a structure of a component used in the information processing system of one embodiment of the present invention.

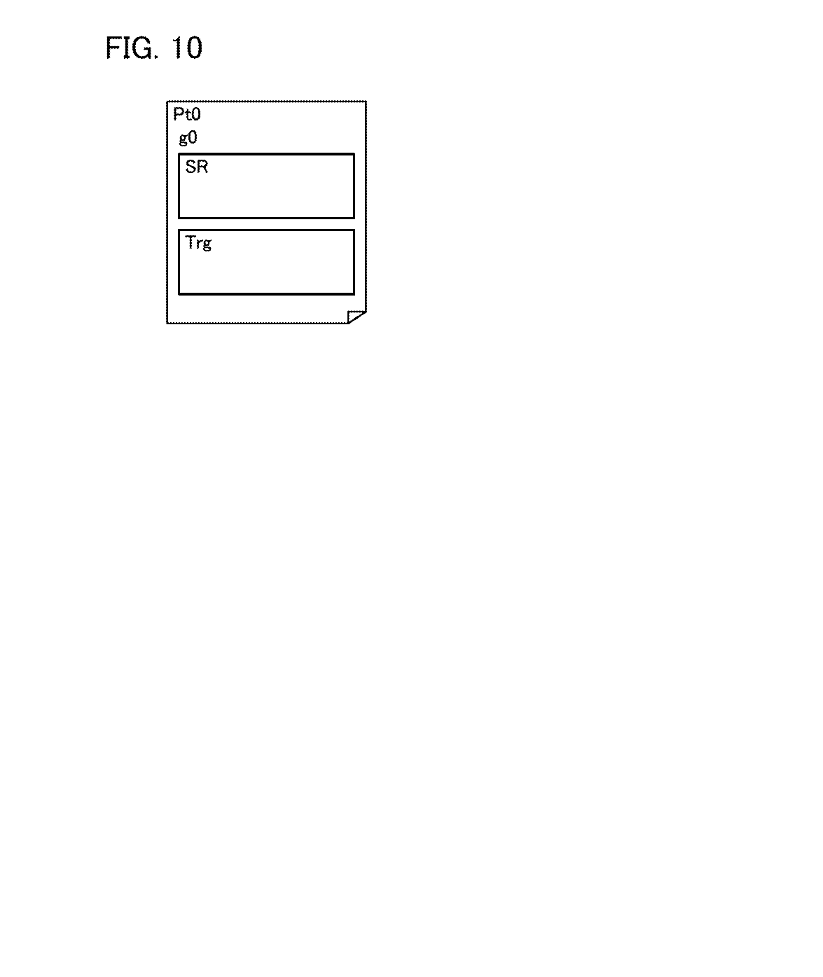

FIG. 10 is a diagram illustrating a structure of a prompt transmitted and received internally in the information processing system of one embodiment of the present invention.

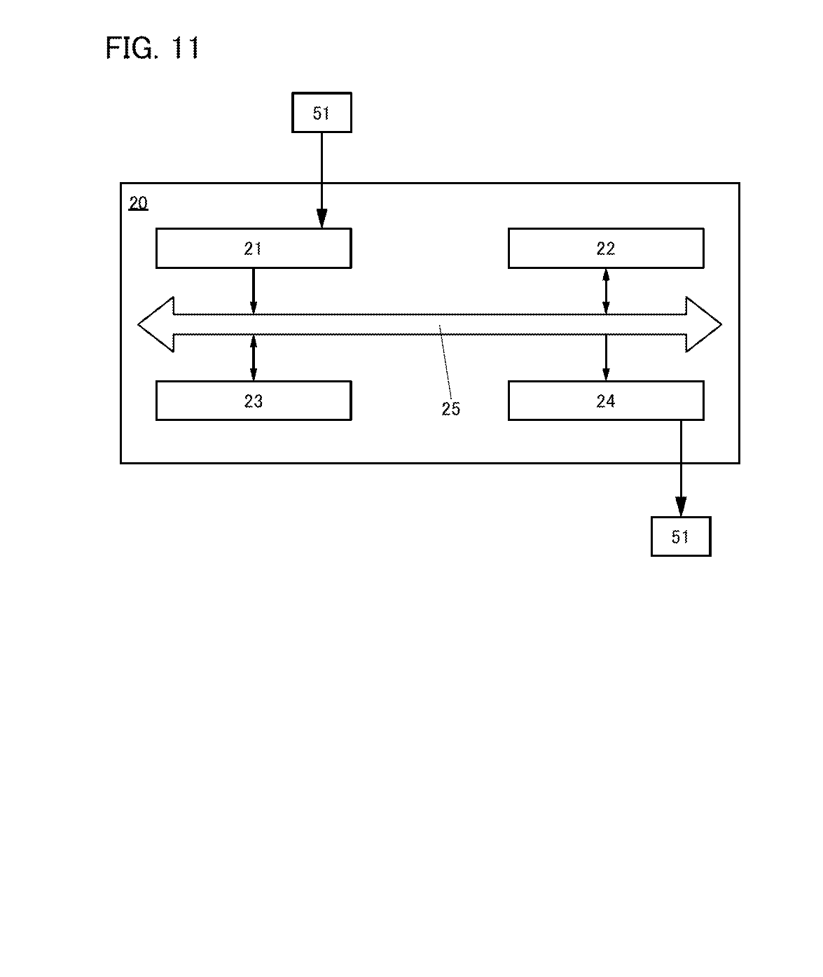

FIG. 11 is a block diagram illustrating a structure of an information processing device that can be used for the information processing system of one embodiment of the present invention.

### Example 1 of information processing system architecture

The information processing system of one embodiment of the present invention includes a component 110, a component 130, and a component 120 (see FIG. 1).

An information processing device having a function of the component 110, an information processing device having a function of the component 130, and an information processing device having a function of the component 120 each include an arithmetic device and a communication device. The communication devices can be connected to one another via a network 51 to construct the information processing system of one embodiment of the present invention.

### Structure example 1 of component 110

The component 110 has a function of receiving a document Doc and a target Trg and transmitting the document Doc and the target Trg to the component 120 (see FIG. 2). Note that the document Doc includes technical information relevant to the target Trg.

For example, a specification required for a product can be used as the target Trg. Existing technology literature relevant to the target Trg can be used as the document Doc. Specifically, the resolution of a display apparatus can be used as the target Trg, and existing technology literature relevant to the resolution of a display apparatus can be used as the document Doc. In addition, the emission efficiency of a light-emitting device can be used as the target Trg, and existing technology literature relevant to the emission efficiency of a light-emitting device can be used as the document Doc.

Furthermore, one or more pieces of literature can be used as the document Doc. Moreover, a material compiled from a plurality of pieces of literature can be used as the document Doc.

For example, a user 99 of the information processing system inputs the document Doc and the target Trg to the component 110. Alternatively, the user 99 inputs a command for selecting and transmitting the document Doc and the target Trg stored in a memory device to the component 110, for example. Specifically, the user 99 of the information processing system inputs the document Doc and the target Trg to the component 110 using an input device such as a keyboard, a mouse, facsimile, or an eye-gaze input device.

The component 110 has a function of receiving an embodiment draft Emb2 and providing the embodiment draft Emb2 to the user 99 of the information processing system, for example. Specifically, with the use of an output device such as a display device, a speaker, a printer, facsimile, or a memory device, the embodiment draft Emb2 is provided to the user 99 of the information processing system.

For example, a document describing how the invention is implemented can be used as the embodiment draft Emb2. In addition, a document described so that a person with ordinary knowledge in the technical field of an invention for which a patent to be granted can implement the invention can be used as the embodiment draft Emb2. The document described so that the invention can be specifically implemented can be used as the embodiment draft Emb2. Moreover, a document including at least one of embodiments inferred to be best can be used as the embodiment draft Emb2. Note that in this specification, the embodiment draft Emb2 and an embodiment Emb3 include a document describing the embodiment of the invention, preferably include a document specifically describing the embodiment of the invention.

### Structure example 1 of component 130

The component 130 has a function of receiving a prompt Pt21 and a prompt Pt22. The component 130 has a function of transmitting a composition Cmp2 and the embodiment draft Emb2 to the component 120 and a function of executing processing using a large language model LLM.

### Structure example 1 of large language model LLM

The large language model LLM has a function of generating the composition Cmp2 in accordance with the prompt Pt21. The large language model LLM has a function of generating the embodiment draft Emb2 in accordance with the prompt Pt22.

A large language model refers to a language model trained on a vast amount of document data. For example, a large language model such as GPT-3 (registered trademark), GPT-3.5, GPT-4 (registered trademark), LaMDA, Llama2, or Llama3 can be used as the large language model LLM. Note that character information written in characters is referred to as a document in this specification and the like. The term "document" includes characters, character strings, texts, sentences, papers, and the like.

### Structure example 1 of component 120

The component 120 has a function of receiving and internally sharing the document Doc, the target Trg, and the composition Cmp2, a function of transmitting the prompt Pt21 and the prompt Pt22 to the component 130, and a function of receiving the embodiment draft Emb2 and transmitting the embodiment draft Emb2 to the component 110.

The component 120 includes a subcomponent 120A (see FIG. 3). In this specification, a structure having a single function or a plurality of functions is referred to as a component or a subcomponent for description convenience.

### Structure example 1 of subcomponent 120A

The subcomponent 120A has a function of creating and executing a prompt chain PC2. The prompt chain PC2 includes the prompt Pt21 and the prompt Pt22 (see FIG. 4A). The prompt chain is a technique in which a response to a prompt is used as part of the next prompt.

### Prompt Pt21

The prompt Pt21 includes an instruction g21, the document Doc, and the target Trg (see FIG. 4B). The instruction g21 includes a procedure for making the large language model propose the composition Cmp2 with reference to the document Doc. Note that the composition Cmp2 is a composition that is not described in the document Doc. The composition Cmp2 is relevant to the target Trg.

For example, the following sentence can be used as the prompt Pt21.

"Make a composition for comparison by combining structures relevant to the target Trg in the document Doc, and propose a composition Cmp2 that is not included in the range of the composition for comparison."

### Prompt Pt22

The prompt Pt22 includes an instruction g22 and the composition Cmp2 (see FIG. 4C). The instruction g22 includes a procedure for making the large language model generate the embodiment draft Emb2 on the basis of the composition Cmp2.

For example, the following sentence can be used as the prompt Pt22.

"Generate an embodiment draft from the composition for comparison and the composition Cmp2 with reference to the document Doc."

In this manner, the composition Cmp2 that is not described in the document Doc can be proposed. In addition, the composition Cmp2 relevant to the target Trg can be proposed. The embodiment draft Emb2 can be generated on the basis of the composition Cmp2. For example, the user of the information processing system can implement the composition Cmp2 in accordance with the embodiment draft Emb2. For example, the user of the information processing system can confirm the effect of the composition Cmp2. Thus, a novel information processing system that is highly convenient, useful, or reliable can be provided.

### Example 2 of information processing system architecture

The information processing system of one embodiment of the present invention includes the component 110, the component 130, and the component 120 (see FIG. 2). Example 2 of information processing system architecture is different from Example 1 of information processing system architecture in that an adjustment request AR is used.

### Structure example 2 of component 110

The component 110 has a function of receiving an adjustment request AR and transmitting the adjustment request AR to the component 120. Note that the adjustment request AR is a request for adjustment of the embodiment draft Emb2.

For example, the user 99 of the information processing system can modify the content of a provided embodiment draft Emb2 with the use of the adjustment request AR. The user 99 can modify a proposed composition Cmp2 with use of the adjustment request AR. The user 99 can modify the target Trg with the use of the adjustment request AR. The user 99 can also adjust the content of the embodiment draft Emb2, the composition Cmp2, or the target Trg on the basis of the user's knowledge, experience, or intuition.

For example, the user 99 of the information processing system inputs the adjustment request AR to the component 110. Alternatively, the user 99 inputs a command for selecting and transmitting the adjustment request AR stored in the memory device to the component 110, for example.

### Structure example 2 of component 130

The component 130 has a function of receiving a prompt Pt23 and transmitting a new embodiment draft Emb2 to the component 120.

### Structure example 2 of large language model LLM

The large language model LLM has a function of generating the new embodiment draft Emb2 in accordance with the prompt Pt23.

### Structure example 2 of component 120

The component 120 has a function of receiving and internally sharing the adjustment request AR.

### Structure example 2 of subcomponent 120A

The subcomponent 120A has a function of creating the prompt Pt23 (see FIG. 3).

### Prompt Pt23

The prompt Pt23 includes an instruction g23, the embodiment draft Emb2, and the adjustment request AR (see FIG. 5). The instruction g23 includes a procedure for making the large language model adjust the embodiment draft Emb2 on the basis of the adjustment request AR.

For example, the following sentence can be used as the prompt Pt23.

"Perform adjustment of the embodiment draft Emb2 on the basis of the adjustment request AR."

In this manner, for example, the user of the information processing system can request adjustment of the embodiment draft Emb2. The information processing system of one embodiment of the present invention can adjust the embodiment draft Emb2 on the basis of the request. For example, the user of the information processing system can request adjustment of the proposed composition Cmp2. Furthermore, the information processing system of one embodiment of the present invention can adjust the composition Cmp2 on the basis of the request. Thus, a novel information processing system that is highly convenient, useful, or reliable can be provided.

### Example 3 of information processing system architecture

The information processing system of one embodiment of the present invention includes the component 110, the component 130, and the component 120 (see FIG. 2). Example 3 of information processing system architecture is different from Examples 1 and 2 of information processing system architecture in that a comparative example Emb1 is provided.

### Structure example 3 of component 110

The component 110 has a function of receiving the comparative example Emb1 and providing the comparative example Emb1 to the user 99 of the information processing system, for example.

For example, a structure disclosed in existing technology literature can be used for the comparative example Emb1. The comparative example Emb1 can be a document that demonstrates an advantageous effect of the composition Cmp2 by comparison between the embodiment draft Emb2 describing the composition Cmp2 and the comparative example Emb1.

### Structure example 3 of component 130

The component 130 has a function of receiving the prompt Pt11 and the prompt Pt12. In addition, the component 130 has a function of transmitting the composition Cmp1 and the comparative example Emb1 to the component 120.

### Structure example 3 of large language model LLM

The large language model LLM has a function of generating the composition Cmp1 in accordance with the prompt Pt11. The large language model LLM has a function of generating the comparative example Emb1 in accordance with the prompt Pt21.

### Structure example 3 of component 120

The component 120 has a function of receiving the comparative example Emb1 and transmitting the comparative example Emb1 to the component 110.

### Structure example 3 of subcomponent 120A

The subcomponent 120A has a function of creating and executing a prompt chain PC1. Note that the prompt chain PC1 includes the prompt Pt11 and the prompt Pt12 (see FIG. 6A).

### Prompt Pt11

The prompt Pt11 includes an instruction g11, the document Doc, and the target Trg (see FIG. 6B). The instruction g11 includes a procedure for making the large language model propose the composition Cmp1 with reference to the document Doc. Note that the composition Cmp1 is a composition described in the document Doc. The composition Cmp1 is relevant to the target Trg.

For example, the following sentence can be used as the prompt Pt21.

"For the document Doc, generate the composition Cmp1 by combining compositions relevant to the target Trg."

Note that when the document Doc includes a plurality of pieces of literature, a composition relevant to the target Trg can be proposed for each piece of literature. The compositions proposed for the pieces of literature can be combined into one composition Cmp1.

### Prompt Pt12

The prompt Pt12 includes an instruction g12 and the composition Cmp1. The instruction g12 includes a procedure for making the large language model generate the comparative example Emb1 on the basis of the composition Cmp1.

For example, the following sentence can be used as the prompt Pt21.

"Generate the comparative example Emb1 from the composition Cmp1 in the category of conventional technology with reference to the document Doc."

In this manner, the composition Cmp1 described in the document Doc can be proposed. In addition, the composition Cmp1 relevant to the target Trg can be proposed. The comparative example Emb1 can be generated on the basis of the composition Cmp1. For example, the user of the information processing system can implement the composition Cmp1 in accordance with the comparative example Emb1. For example, the user of the information processing system can confirm the effect of the composition Cmp1. Thus, a novel information processing system that is highly convenient, useful, or reliable can be provided.

### Example 4 of information processing system architecture

The information processing system of one embodiment of the present invention includes the component 110, the component 130, and the component 120 (see FIG. 2). Example 4 of the information processing system architecture is different from Example 1 to Example 3 of the information processing system architecture in that an evaluation Evl is used.

### Structure example 4 of component 110

The component 110 has a function of receiving the evaluation Evl and transmitting the evaluation Evl to the component 120. Note that the evaluation Evl is an evaluation result of the effect of the composition Cmp2.

For example, the user 99 of the information processing system can evaluate the effect by implementing the content of the provided embodiment draft Emb2. In addition, the user 99 evaluate the effect by implementing the proposed composition Cmp2. The evaluation result can be used as the evaluation Evl. Specifically, the user 99 can evaluate the emission efficiency by implementing the proposed composition Cmp2 of a light-emitting device, and the measured emission efficiency can be used as the evaluation Evl.

For example, the user 99 of the information processing system inputs the evaluation Evl to the component 110. Alternatively, the user 99 inputs a command for selecting and transmitting the evaluation Evl stored in the memory device to the component 110, for example.

The component 110 has a function of receiving an embodiment Emb3 and providing the embodiment Emb3 to the user 99 of the information processing system, for example. Specifically, with use of an output device such as a display device, a speaker, a printer, facsimile, or a memory device, the embodiment Emb3 is provided to the user 99 of the information processing system.

For example, a document in which the evaluation result of the effect of the composition Cmp2 is added to the embodiment draft Emb2 describing how the invention is implemented can be used as the embodiment Emb3. In addition, a document described so that a person with ordinary knowledge in the technical field of the invention for which a patent is to be granted can implement the invention can be used as the embodiment Emb3.

### Structure example 4 of component 130

The component 130 has a function of receiving a prompt Pt3 and transmitting the embodiment Emb3 to the component 120.

### Structure example 4 of large language model LLM

The large language model LLM has a function of generating the embodiment Emb3 in accordance with the prompt Pt3.

### Structure example 4 of component 120

The component 120 has a function of receiving and internally sharing the evaluation Evl and a function of receiving the embodiment Emb3 and transmitting the embodiment Emb3 to the component 110.

### Structure example 4 of subcomponent 120A

The subcomponent 120A has a function of creating the prompt Pt3.

### Prompt Pt3

The prompt Pt3 includes an instruction g3, the embodiment draft Emb2, and the evaluation Evl (see FIG. 7). The instruction g3 includes a procedure for making the large language model generate the embodiment Emb3 on the basis of the embodiment draft Emb2 and the evaluation Evl.

For example, the following sentence can be used as the prompt Pt3.

"Complete the embodiment Emb3 by adding the evaluation Evl to the embodiment draft Emb2."

In this manner, the embodiment Emb3 can be generated by adding the evaluation Evl to the embodiment draft Emb2. The composition Cmp2 that is not described in the document Doc and the evaluation Evl of the composition Cmp2 can be described in the embodiment Emb3. Moreover, a significant effect of the composition Cmp2 can be described in the embodiment Emb3 on the basis of the evaluation Evl. In addition, the action of the composition Cmp2 can be described in the embodiment Emb3. Thus, a novel information processing system that is highly convenient, useful, or reliable can be provided.

### Example 5 of information processing system architecture

The information processing system of one embodiment of the present invention includes the component 110, the component 130, and the component 120 (see FIG. 8). Example 5 of the information processing system architecture is different from Example 1 to Example 4 of the information processing system architecture in that a title of an invention ToI, a target Trg, a database DB, and a management system DBMS are used.

### Structure example 5 of component 110

The component 110 has a function of receiving the title of the invention ToI and the target Trg and transmitting the title of the invention ToI and the target Trg to the component 120.

For example, a generic term of a product can be used as the title of the invention ToI. A manufacturing method of a product can be used as the title of the invention ToI. The specifications required for a manufacturing method of a product or a product can be used as the target Trg.

For example, the user 99 of the information processing system inputs the title of the invention ToI to the component 110. Alternatively, the user 99 inputs a command for selecting and transmitting the title of the invention ToI stored in the memory device to the component 110, for example. Specifically, the user 99 of the information processing system inputs the title of the invention ToI to the component 110 using an input device such as a keyboard, a mouse, facsimile, or an eye-gaze input device.

The component 110 has a function of receiving the document Doc and providing the document Doc to the user 99 of the information processing system, for example. Specifically, the component 110 provides the document Doc to the user 99 of the information processing system with use of an output device such as a display device, a speaker, a printer, facsimile, or a memory device.

### Structure example 5 of component 130

The component 130 has a function of receiving a prompt Pt0 and transmitting the document Doc to the component 120.

### Structure example 5 of large language model LLM

The large language model LLM has a function of selecting the document Doc from a search result SR in accordance with the prompt Pt0.

### Structure example 5 of component 120

The component 120 has a function of receiving and internally sharing the title of the invention ToI and the target Trg and a function of receiving the document Doc and transmitting the document Doc to the component 110.

The component 120 includes a subcomponent 120B (see FIG. 9).

### Structure example 1 of subcomponent 120B

The subcomponent 120B includes the database DB and the management system DBMS. Note that the database DB stores one or more pieces of technical literature. The management system DBMS has a function of generating the search result SR in accordance with a query Que.

For example, any of a patent database, an academic paper database, and a variety of databases published on the Internet can be used as the database DB.

### Structure example 5 of subcomponent 120A

The subcomponent 120A has a function of creating the query Que and the prompt Pt0.

### Query Que

The query Que includes a request to collect literature relevant to the title of the invention ToI and the target Trg from the database DB as the search result SR.

For example, the query Que can be created by using the title of the invention ToI and the target Trg as search keywords. Furthermore, relevant public publications can be collected from a patent database as the search result SR with use of the query Que.

For example, it is possible to make the component 130 create the query Que by using the following sentences as a prompt.

"Propose patent classification and keywords relevant to the title of the invention ToI and the target Trg. Then, provide synonyms of the keywords. Lastly, create a search query using the patent classification, the keywords, and the synonyms of the keywords."

### Prompt Pt0

The prompt Pt0 includes the instruction g0, the search result SR, and the target Trg (see FIG. 10). The instruction g0 includes a procedure for making the large language model select an appropriate document Doc relevant to the target Trg on the basis of the search result SR.

For example, the following sentence can be used as the prompt Pt21.

"For reference, select appropriate literature relevant to the target Trg from a group of literature in the search result SR shown below."

In this manner, literature relevant to the title of the invention ToI and the target Trg can be collected from the database DB as the search result SR. In addition, an appropriate document Doc relevant to the target Trg can be selected from the search result SR. Thus, a novel information processing system that is highly convenient, useful, or reliable can be provided.

### Structure example of information processing device

An information processing device 20 that can be used for the information processing system of one embodiment of the present invention includes, for example, an input unit 21, a memory unit 22, a processing unit 23, an output unit 24, and a transmission path 25 (see FIG. 11).

Although the block diagram in drawings attached to this specification illustrates components classified by their functions as independent blocks, it is difficult to classify actual components by their functions completely and one component can have a plurality of functions. For example, part of the processing unit 23 functions as the input unit 21 in some cases. In addition, one function can be involved in a plurality of components. For example, processing executed in the processing unit 23 is sometimes executed by a different information processing device depending on the processing.

### Input unit 21

The input unit 21 can receive data from the outside of the information processing device. For example, the input unit 21 receives data via the network 51. Specifically, a device such as a personal computer having a communication port or a communication function can be used.

The input unit 21 supplies the received data to one or both of the memory unit 22 and the processing unit 23 via the transmission path 25.

### Memory unit 22

The memory unit 22 has a function of storing a program to be executed by the processing unit 23. The memory unit 22 can also have a function of storing data generated by the processing unit 23 (e.g., an arithmetic operation result, an analysis result, or an inference result), data received by the input unit 21, and the like.

The memory unit 22 can include a database. The information processing device can include a database in addition to the memory unit 22. The information processing device can have a function of extracting data from a database outside the memory unit 22, the information processing device, or the information processing system. In addition, the information processing device can have a function of extracting data from both of its own database and an external database.

One or both of a storage and a file server can be used for the memory unit 22. In addition, a database in which a path of a file stored in the file server is recorded can be used for the memory unit 22.

The memory unit 22 includes at least one of a volatile memory and a nonvolatile memory. Examples of the volatile memory include a dynamic random access memory (DRAM) and a static random access memory (SRAM). Examples of the nonvolatile memory include a resistive random access memory (ReRAM, also referred to as a resistance-change memory), a phase change random access memory (PRAM), a ferroelectric random access memory (FeRAM), a magnetoresistive random access memory (MRAM, also referred to as a magnetoresistive memory), and a flash memory. The memory unit 22 can include at least one of a NOSRAM (registered trademark) and a DOSRAM (registered trademark). The memory unit 22 can include a storage media drive. Examples of the storage media drive include a hard disk drive (HDD) and a solid state drive (SSD).

Note that the NOSRAM is an abbreviation for nonvolatile oxide semiconductor random access memory (RAM). The NOSRAM refers to a memory in which a two-transistor (2T) or three-transistor (3T) gain cell is used as a memory cell and the transistor includes a metal oxide in its channel formation region (such a transistor is also referred to as an OS transistor). The OS transistor has an extremely low current that flows between a source and a drain in an off state, that is, an extremely low leakage current. The NOSRAM retains electric charge corresponding to data in memory cells by using characteristics of extremely low leakage current, thereby capable of being used as a nonvolatile memory. In particular, the NOSRAM is capable of reading retained data without destruction (non-destructive reading), and thus is suitable for arithmetic processing in which only data read operations are repeated many times. The NOSRAM can have large data capacity when stacked in layers, and thus, a semiconductor device in which the NOSRAM is used for a large-scale memory such as a cache memory, a main memory, or a storage memory can have higher performance.

The DOSRAM is an abbreviation for dynamic oxide semiconductor RAM and refers to a RAM including a one-transistor (1T) and one-capacitor (1C) memory cell. The DOSRAM is a DRAM formed using an OS transistor and temporarily stores information sent from the outside. The DOSRAM is a memory utilizing a low off-state current of an OS transistor.

In this specification and the like, a metal oxide means an oxide of a metal in a broad sense. Metal oxides are classified into an oxide insulator, an oxide conductor (including a transparent oxide conductor), an oxide semiconductor (also simply referred to as an OS), and the like. For example, in the case where a metal oxide is used in a semiconductor layer of a transistor, the metal oxide is referred to as an oxide semiconductor in some cases.

The metal oxide included in the channel formation region preferably contains indium (In). When the metal oxide included in the channel formation region is a metal oxide containing indium, the carrier mobility (electron mobility) of the OS transistor is high. For example, indium oxide (InOx) or indium gallium zinc oxide (In-Ga-Zn oxide, also referred to as "IGZO") can be used for the channel formation region. The metal oxide included in the channel formation region is preferably an oxide semiconductor containing an element M. The element M is preferably at least one of aluminum (Al), gallium (Ga), and tin (Sn). Other elements that can be used as the element M are boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that a combination of two or more of the above elements may be used as the element M. The element M is, for example, an element that has high bonding energy with oxygen. The element M has higher bonding energy with oxygen than indium does, for example. The metal oxide included in the channel formation region is preferably a metal oxide containing zinc (Zn). The metal oxide containing zinc is easily crystallized in some cases.

The metal oxide included in the channel formation region is not limited to the metal oxide containing indium. The metal oxide included in the channel formation region may be a metal oxide that does not contain indium but contains any of zinc, gallium, and tin, e.g., zinc tin oxide and gallium tin oxide.

### Processing unit 23

The processing unit 23 has a function of executing processing such as arithmetic operation, analysis, and inference with the use of data supplied from one or both of the input unit 21 and the memory unit 22. The processing unit 23 can supply generated data (e.g., an arithmetic operation result, an analysis result, or an inference result) to one or both of the memory unit 22 and the output unit 24.

The processing unit 23 has a function of obtaining data from the memory unit 22. The processing unit 23 can also have a function of storing or registering data in the memory unit 22.

The processing unit 23 can include an arithmetic circuit, for example. The processing unit 23 can include, for example, a central processing unit (CPU). The processing unit 23 can also include a graphics processing unit (GPU). Furthermore, the processing unit 23 can include a neural processing unit or a neural network processing unit (NPU).

The processing unit 23 can include a microprocessor such as a digital signal processor (DSP). The microprocessor can be achieved with a programmable logic device (PLD) such as a field programmable gate array (FPGA) or a field programmable analog array (FPAA). The processing unit 23 can also include a quantum processor. The processing unit 23 can interpret and execute instructions from various programs with the use of a processor to execute various kinds of data processing and program control. The programs that can be executed by the processor are stored in at least one of the memory unit 22 and a memory region of the processor.

The processing unit 23 can include a main memory. The main memory includes at least one of a volatile memory such as a RAM and a nonvolatile memory such as a read only memory (ROM). The main memory can include at least one of the above-described NOSRAM and DOSRAM.

Examples of the RAM include a DRAM and an SRAM; a virtual memory space is assigned and utilized as a working space of the processing unit 23. An operating system, an application program, a program module, program data, a look-up table, and the like that are stored in the memory unit 22 are loaded into the RAM for execution. The data, program, and program module that are loaded into the RAM are each directly accessed and operated by the processing unit 23.

The ROM can store a basic input/output system (BIOS), firmware, and the like for which rewriting is not needed. Examples of the ROM include a mask ROM, a one-time programmable read only memory (OTPROM), and an erasable programmable read only memory (EPROM). Examples of the EPROM include an ultra-violet erasable programmable read only memory (UV-EPROM) capable of erasing stored data by irradiation with ultraviolet rays, an electrically erasable programmable read only memory (EEPROM), and a flash memory.

The processing unit 23 can include one or both of an OS transistor and a transistor including silicon in its channel formation region (Si transistor).

The processing unit 23 preferably includes an OS transistor. Since the OS transistor has an extremely low off-state current, a long data retention period can be ensured with the use of the OS transistor as a switch for retaining electric charge (data) that has flowed into a capacitor functioning as a memory element. When this feature is imparted to at least one of a register and a cache memory included in the processing unit, the processing unit can be operated only when needed, and otherwise can be off while information processed immediately before turning off the processing unit is stored in the memory element. In other words, normally-off computing is possible and the power consumption of the information processing system can be reduced.

The information processing device preferably uses AI for at least part of its processing.

In particular, the information processing device preferably uses an artificial neural network (ANN, hereinafter also simply referred to as a neural network). The neural network can be constructed with circuits (hardware) or programs (software).

In this specification and the like, the neural network indicates a general model having the capability of solving problems, which is modeled on a biological neural network and determines the connection strength of neurons by learning. The neural network includes an input layer, an intermediate layer (hidden layer), and an output layer.

In the description of the neural network in this specification and the like, determining a connection strength of neurons (also referred to as weight coefficients) from the existing information is referred to as "learning" in some cases.

In this specification and the like, drawing a new conclusion from a neural network formed with the connection strength obtained by learning is referred to as "inference" in some cases.

### Output unit 24

The output unit 24 can output at least one of an arithmetic operation result, an analysis result, and an inference result in the processing unit 23 to the outside of the information processing device. For example, the output unit 24 can transmit data via the network 51. Specifically, a device such as a personal computer having a communication port or a communication function can be used. Furthermore, a device having a communication function may be used as each of the input unit 21 and the output unit 24.

### Transmission path 25

The transmission path 25 has a function of transmitting data. Data transmission and reception between the input unit 21, the memory unit 22, the processing unit 23, and the output unit 24 can be performed via the transmission path 25. Specifically, an external bus, a LAN, or the Internet can be used for the transmission path 25.

Note that this embodiment can be combined with any of the other embodiments in this specification as appropriate.

### Embodiment 2

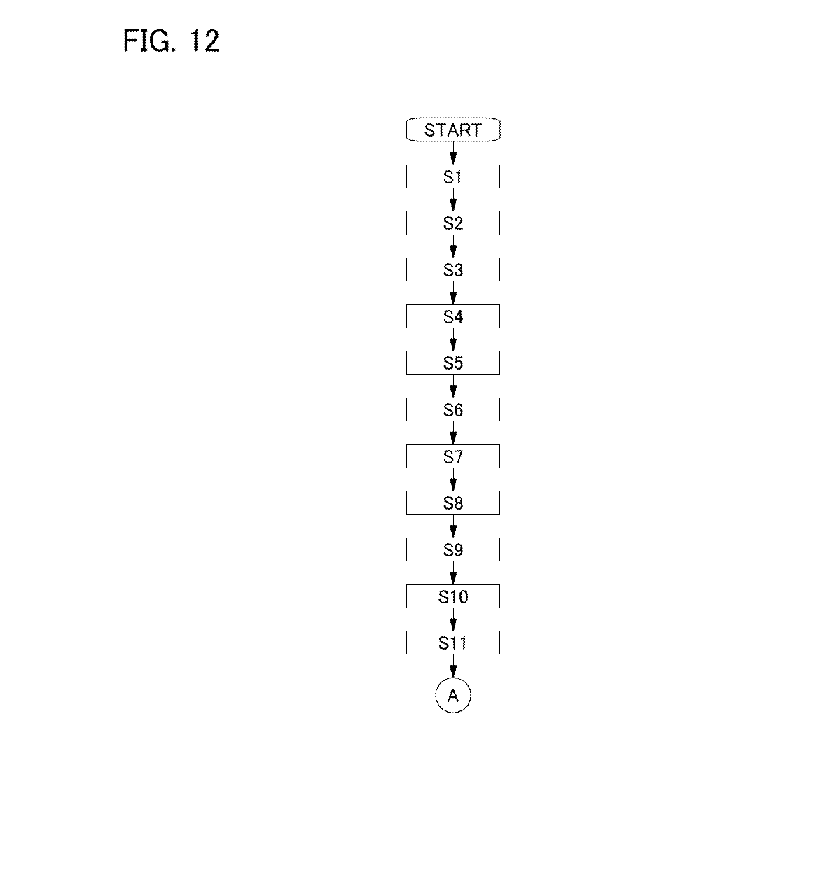

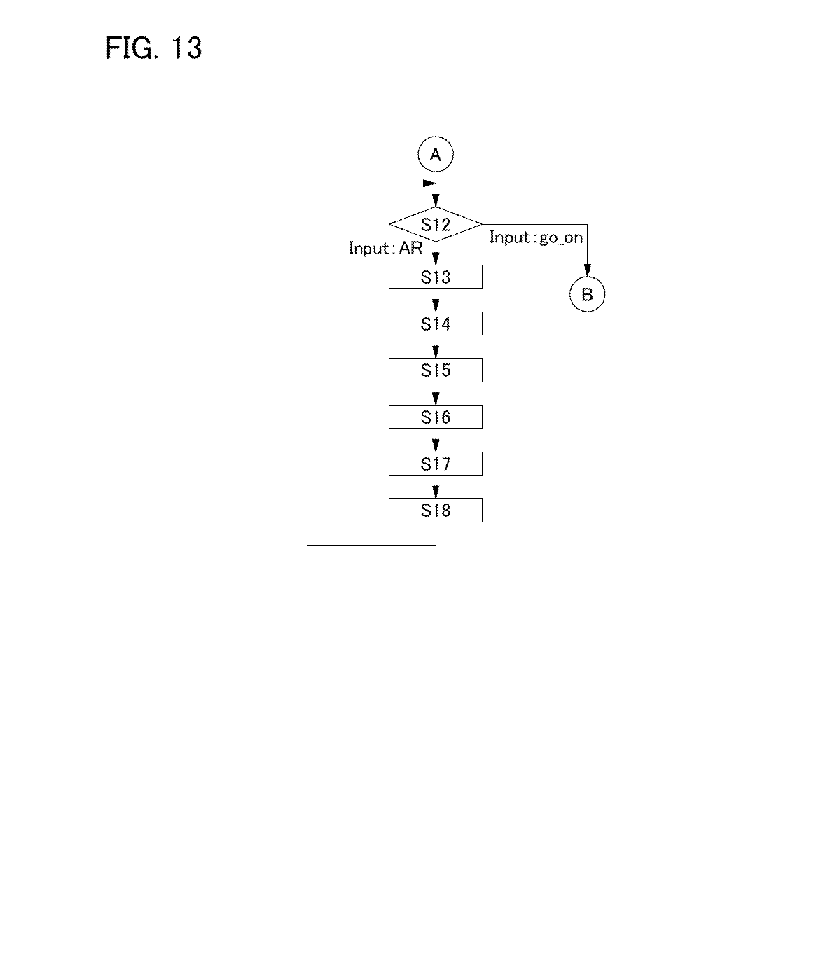

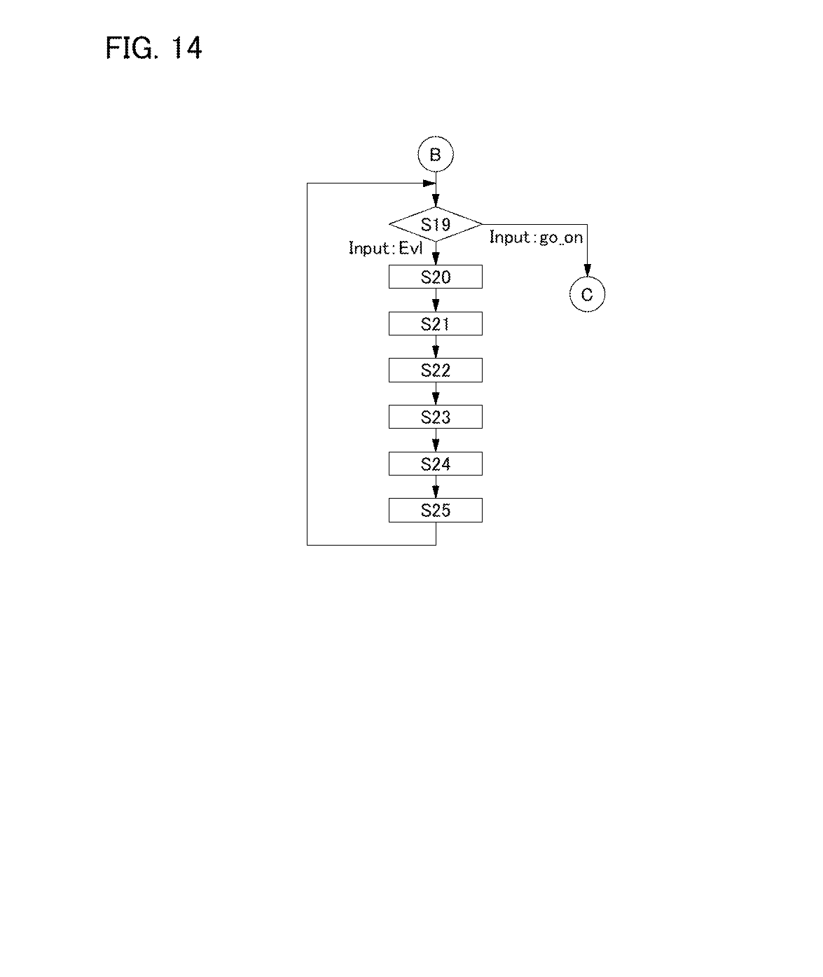

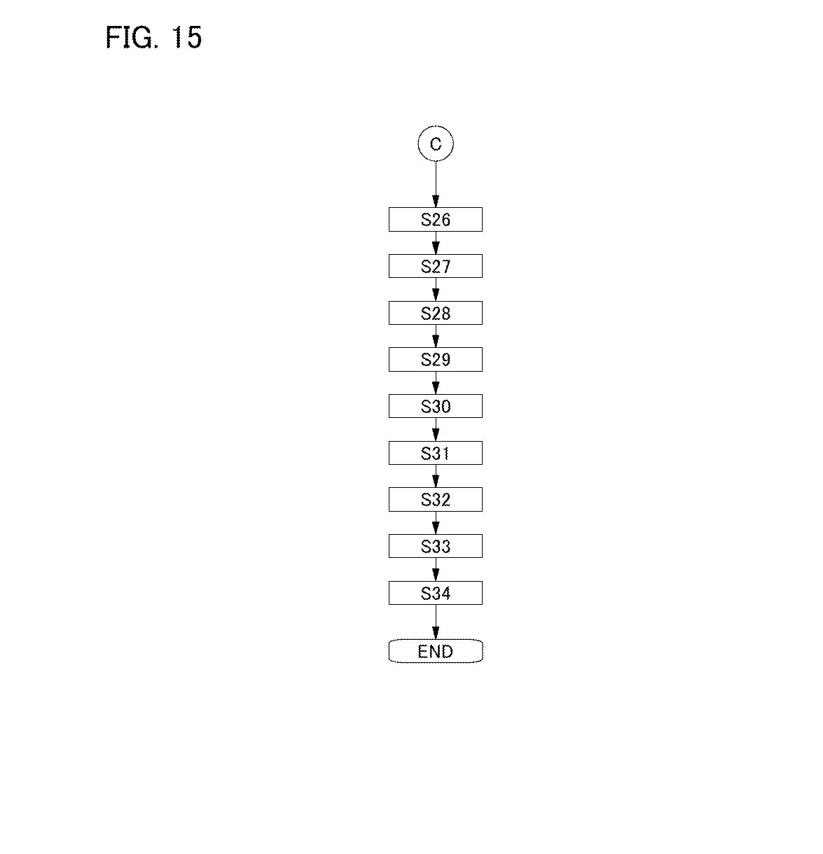

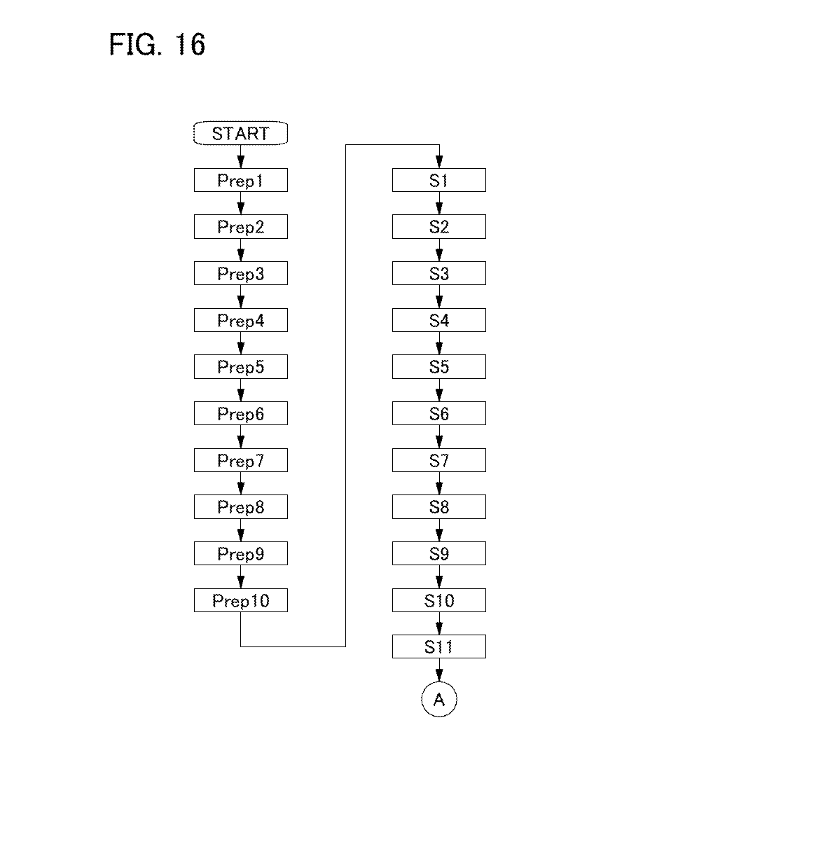

In this embodiment, an information processing method of one embodiment of the present invention will be described with reference to FIG. 12, FIG. 13, FIG. 14, FIG. 15, and FIG. 16.

FIG. 12 is a flowchart showing an information processing method of one embodiment of the present invention.

FIG. 13 is a flowchart showing an information processing method of one embodiment of the present invention.

FIG. 14 is a flowchart showing an information processing method of one embodiment of the present invention.

FIG. 15 is a flowchart showing an information processing method of one embodiment of the present invention.

FIG. 16 is a flowchart showing an information processing method of one embodiment of the present invention.

### Example 1 of information processing method

An information processing method of one embodiment of the present invention includes Steps S1 to S11 (see FIG. 12).

### Step S1

In Step S1, the component 110 receives the document Doc and the target Trg and transmits the document Doc and the target Trg to the component 120. Note that the document Doc includes technical information relevant to the target Trg.

For example, the user 99 of the information processing system inputs the document Doc and the target Trg to the component 110. Alternatively, the user 99 inputs a command for selecting and transmitting the document Doc and the target Trg stored in the memory device to the component 110, for example.

### Step S2

In Step S2, the component 120 receives and internally shares the document Doc and the target Trg.

The component 120 includes the subcomponent 120A. The subcomponent 120A has a function of creating and executing the prompt chain PC2, and the prompt chain PC2 includes the prompt Pt21 and the prompt Pt22.

### Step S3

In Step S3, the component 120 transmits the prompt Pt21 to the component 130.

The prompt Pt21 includes the instruction g21, the document Doc, and the target Trg. Note that the instruction g21 includes a procedure for making the large language model propose the composition Cmp2 with reference to the document Doc. In addition, the composition Cmp2 is a composition that is not described in the document Doc and is relevant to the target Trg.

### Step S4

In Step S4, the component 130 receives the prompt Pt21 and generates the composition Cmp2 using the large language model LLM.

### Step S5

In Step S5, the component 130 transmits the composition Cmp2 to the component 120.

### Step S6

In Step S6, the component 120 receives and internally shares the composition Cmp2.

### Step S7

In Step S7, the component 120 transmits the prompt Pt22 to the component 130.

The prompt Pt22 includes the instruction g22 and the composition Cmp2, and the instruction g22 includes a procedure for making the large language model generate the embodiment draft Emb2 on the basis of the composition Cmp2.

### Step S8

In Step S8, the component 130 receives the prompt Pt22 and generates the embodiment draft Emb2 using the large language model LLM.

### Step S9

In Step S9, the component 130 transmits the embodiment draft Emb2 to the component 120.

### Step S10

In Step S10, the component 120 receives the embodiment draft Emb2 and transmits the embodiment draft Emb2 to the component 110.

### Step S11

In Step S11, the component 110 receives the embodiment draft Emb2 and provides the embodiment draft Emb2 to the user 99 of the information processing system, for example. In addition, Step S12 can be executed following Step S11.

In this manner, the composition Cmp2 that is not described in the document Doc can be proposed. In addition, the composition Cmp2 relevant to the target Trg can be proposed. The embodiment draft Emb2 can be generated on the basis of the composition Cmp2. For example, the user of the information processing system can implement the composition Cmp2 in accordance with the embodiment draft Emb2. For example, the user of the information processing system can confirm the effect of the composition Cmp2. Thus, a novel information processing method that is highly convenient, useful, or reliable can be provided.

### Example 2 of information processing method

An information processing method of one embodiment of the present invention includes Steps S12 to S18 (see FIG. 13).

### Step S12

In Step S12, when the adjustment request AR is input (Input: AR), the component 110 receives the adjustment request AR and transmits the adjustment request AR to the component 120. When the adjustment request AR is not input in Step S12, the process can proceed to Step S19 (Input: go_on).

For example, the user 99 of the information processing system inputs the adjustment request AR or the proceeding to Step S19 to the component 110. Alternatively, the user 99 inputs a command for selecting and transmitting the adjustment request AR stored in the memory device or the proceeding to Step S19 to the component 110, for example.

### Step S13

In Step S13, the component 120 receives and internally shares the adjustment request AR. The subcomponent 120A has a function of creating the prompt Pt23.

### Step S14

In Step S14, the component 120 transmits the prompt Pt23 to the component 130.

The prompt Pt23 includes the instruction g23, the embodiment draft Emb2, and the adjustment request AR, and the instruction g23 includes a procedure for making the large language model adjust the embodiment draft Emb2 on the basis of the adjustment request AR.

### Step S15

In Step S15, the component 130 receives the prompt Pt23 and adjusts the embodiment draft Emb2 using the large language model LLM.

### Step S16

In Step S16, the component 130 transmits the embodiment draft Emb2 to the component 120.

### Step S17

In Step S17, the component 120 transmits the embodiment draft Emb2 to the component 110.

### Step S18

In Step S18, the component 110 receives the embodiment draft Emb2 and provides the embodiment draft Emb2 to the user 99 of the information processing system, for example. In addition, Step S19 can be executed following Step S18.

In this manner, for example, the user of the information processing system can request adjustment of the embodiment draft Emb2. The information processing system of one embodiment of the present invention can adjust the embodiment draft Emb2 on the basis of the request. For example, the user of the information processing system can request adjustment of the proposed composition Cmp2. Furthermore, the information processing system of one embodiment of the present invention can adjust the composition Cmp2 on the basis of the request. Thus, a novel information processing method that is highly convenient, useful, or reliable can be provided.

### Example 3 of information processing method

An information processing method of one embodiment of the present invention includes Steps S19 to S25 (see FIG. 14).

### Step S19

In Step S19, when the evaluation Evl is input (Input: Evl), the component 110 receives the evaluation Evl and transmits the evaluation Evl to the component 120. When the evaluation Evl is not input in Step S19, the process can proceed to Step S26 (Input: go_on).

For example, the user 99 of the information processing system inputs the evaluation Evl or the proceeding to Step S26 to the component 110. Alternatively, the user 99 inputs a command for selecting and transmitting the evaluation Evl stored in the memory device or the proceeding to Step S26 to the component 110, for example.

### Step S20

In Step S20, the component 120 receives and internally shares the evaluation Evl. The subcomponent 120A has a function of creating the prompt Pt3.

### Step S21

In Step S21, the component 120 transmits the prompt Pt3 to the component 130. The prompt Pt3 includes the instruction g3, the embodiment draft Emb2, and the evaluation Evl, and the instruction g3 includes a procedure for making the large language model LLM generate the embodiment Emb3 on the basis of the embodiment draft Emb2 and the evaluation Evl.

### Step S22

In Step S22, the component 130 receives the prompt Pt3 and generates the embodiment Em3b using the large language model LLM.

### Step S23

In Step S23, the component 130 transmits the embodiment Emb3 to the component 120.

### Step S24

In Step S24, the component 120 receives the embodiment Emb3 and transmits the embodiment Emb3 to the component 110.

### Step S25

In Step S25, the component 110 receives the embodiment Emb3 and provides the embodiment Emb3 to the user 99 of the information processing system, for example. In addition, Step S26 can be executed following Step S25.

In this manner, the embodiment Emb3 can be generated by adding the evaluation Evl to the embodiment draft Emb2. The composition Cmp2 that is not described in the document Doc and the evaluation Evl of the composition Cmp2 can be described in the embodiment Emb3. Moreover, a significant effect of the composition Cmp2 can be described in embodiment Emb3 on the basis of the evaluation Evl. In addition, the action of the composition Cmp2 can be described in the embodiment Emb3. Thus, a novel information processing method that is highly convenient, useful, or reliable can be provided.

### Example 4 of information processing method

An information processing method of one embodiment of the present invention includes Steps S26 to S34 (see FIG. 15).

Note that the subcomponent 120A has a function of creating and executing the prompt chain PC1, and the prompt chain PC1 includes the prompt Pt11 and the prompt Pt12.

### Step S26

In Step S26, the component 120 transmits the prompt Pt11 to the component 130.

The prompt Pt11 includes the instruction g11, the document Doc, and the target Trg. Note that the instruction g11 includes a procedure for making the large language model propose the composition Cmp1 with reference to the document Doc. In addition, the composition Cmp1 is a composition that is described in the document Doc, and the composition Cmp1 is relevant to the target Trg.

### Step S27

In Step S27, the component 130 receives the prompt Pt11 and generates the composition Cmp1 using the large language model LLM.

### Step S28

In Step S28, the component 130 transmits the composition Cmp1 to the component 120.

### Step S29

In Step S29, the component 120 receives and internally shares the composition Cmp1.

### Step S30

In Step S30, the component 120 transmits the prompt Pt12 to the component 130.

The prompt Pt12 includes the instruction g12 and the composition Cmp1, and the instruction g12 includes a procedure for making the large language model generate the comparative example Emb1 on the basis of the composition Cmp1.

### Step S31

In Step S31, the component 130 receives the prompt Pt12 and generates the comparative example Emb1 using the large language model LLM.

### Step S32

In Step S32, the component 130 transmits the comparative example Emb1 to the component 120.

### Step S33

In Step S33, the component 120 receives the comparative example Emb1 and transmits the comparative example Emb1 to the component 110.

### Step S34

In Step S34, the component 110 receives the comparative example Emb1 and provides the comparative example Emb1 to the user 99 of the information processing system, for example.

In this manner, the composition Cmp1 described in the document Doc can be proposed. In addition, the composition Cmp1 relevant to the target Trg can be proposed. The comparative example Emb1 can be generated on the basis of the composition Cmp1. For example, the user of the information processing system can implement the composition Cmp1 in accordance with the comparative example Emb1. For example, the user of the information processing system can confirm the effect of the composition Cmp1. Thus, a novel information processing method that is highly convenient, useful, or reliable can be provided.

### Example 5 of information processing method

An information processing method of one embodiment of the present invention includes a pre-processing step Prep1 to a pre-processing step Prep10 (see FIG. 16).

### Pre-processing Step Prep1

In the pre-processing step Prep1, the component 110 receives the title of the invention ToI and the target Trg and transmits the title of the invention ToI and the target Trg to the component 120.

### Pre-processing Step Prep2

In the pre-processing step Prep2, the component 120 receives and internally shares the title of the invention ToI and the target Trg.

The component 120 includes the subcomponent 120A and the subcomponent 120B. The subcomponent 120B includes the database DB and the management system DBMS, and the database DB stores technical literature.

### Pre-processing Step Prep3

In the pre-processing step Prep3, the subcomponent 120A creates the query Que. Note that the query Que includes a request to collect literature relevant to the title of the invention ToI and the target Trg from the database DB as the search result SR.

### Pre-processing Step Prep4

In the pre-processing step Prep4, the management system DBMS generates the search result SR in accordance with the query Que.

### Pre-processing Step Prep5

In the pre-processing step Prep5, the subcomponent 120A creates the prompt Pt0. Note that the prompt Pt0 includes the instruction g0, the search result SR, and the target Trg, and the

instruction g0 includes a procedure for making the large language model select an appropriate document Doc relevant to the target Trg on the basis of the search result SR.

### Pre-processing Step Prep6

In the pre-processing step Prep6, the component 120 transmits the prompt Pt0 to the component 130.

### Pre-processing Step Prep7

In the pre-processing step Prep7, the component 130 receives the prompt Pt0 and generates the document Doc using the large language model LLM.

### Pre-processing Step Prep8

In the pre-processing step Prep8, the component 130 transmits the document Doc to the component 120.

### Pre-processing Step Prep9

In the pre-processing step Prep9, the component 120 receives the document Doc and transmits the document Doc to the component 110.

### Pre-processing Step Prep10

In the pre-processing step Prep10, the component 110 receives the document Doc. In addition, following the pre-processing step Prep10, the process can proceed to Step S1 in Example 1 of the information processing method of this embodiment.

In this manner, literature relevant to the title of the invention ToI and the target Trg can be collected from the database DB as the search result SR. An appropriate document Doc relevant to the target Trg can be selected from the search result SR. Thus, a novel information processing method that is highly convenient, useful, or reliable can be provided.

Note that this embodiment can be combined with any of the other embodiments in this specification as appropriate.

This application is based on Japanese Patent Application Serial No. 2025-030999 filed with Japan Patent Office on February 28, 2025, the entire contents of which are hereby incorporated by reference.

What is claimed is:

1. An information processing system comprising:
a plurality of information processing devices,
wherein the information processing system is configured to:
receive a document and a target;
provide an embodiment draft; and
execute processing using a large language model,
wherein the document comprises technical information relevant to the target,
wherein the large language model is configured to generate a first composition in accordance with a first prompt and to generate the embodiment draft in accordance with a second prompt,
wherein the first prompt comprises a first instruction, the document, and the target,
wherein the first instruction comprises a procedure for making the large language model propose the first composition with reference to the document,
wherein the first composition is a composition that is not described in the document and is relevant to the target,
wherein the second prompt comprises a second instruction and the first composition, and
wherein the second instruction comprises a procedure for making the large language model generate the embodiment draft on the basis of the first composition.

2. An information processing system comprising:
a first component configured to receive a document and a target, to transmit the document and the target to the third component, to receive a first embodiment draft, and to provide the first embodiment draft;
a second component configured to receive a first prompt and a second prompt, to transmit a first composition and the first embodiment draft to the third component, and to execute processing using a large language model configured to generate the first composition in accordance with the first prompt and to generate the first embodiment draft in accordance with the second prompt; and
a third component configured to receive and internally share the document, the target, and the first composition, to transmit the first prompt and the second prompt to the second component, to receive the first embodiment draft, and to transmit the first embodiment draft to the first component,
wherein the document comprises technical information relevant to the target,
wherein the third component comprises a first subcomponent configured to create and execute a first prompt chain including the first prompt and the second prompt,
wherein the first prompt comprises a first instruction, the document, and the target,
wherein the large language model is configured to propose the first composition with reference to the document in accordance with a procedure included in the first instruction,
wherein the first composition is a composition that is not described in the document,
wherein the first composition is relevant to the target,
wherein the second prompt comprises a second instruction and the first composition, and
wherein the large language model is configured to generate the first embodiment draft on the basis of the first composition in accordance with a procedure included in the second instruction.

3. The information processing system according to claim 2,
wherein the first component is configured to receive an adjustment request and to transmit the adjustment request to the third component,
wherein the adjustment request is a request for adjusting the first embodiment draft,
wherein the second component is configured to receive a third prompt and to transmit a second embodiment draft to the third component,
wherein the large language model is configured to generate the second embodiment draft in accordance with the third prompt,
wherein the third component is configured to receive and internally share the adjustment request,
wherein the first subcomponent is configured to create the third prompt,
wherein the third prompt comprises a third instruction, the first embodiment draft, and the adjustment request, and
wherein the large language model is configured to adjust the first embodiment draft on the basis of the adjustment request in accordance with a procedure included in the third instruction.

4. The information processing system according to claim 3,
wherein the first component is configured to receive a comparative example and to provide the comparative example,
wherein the second component is configured to receive a fourth prompt and a fifth prompt and to transmit a second composition and the comparative example to the third component,
wherein the large language model is configured to generate the second composition in accordance with the fourth prompt and to generate the comparative example in accordance with the fifth prompt,
wherein the third component is configured to receive the comparative example and to transmit the comparative example to the first component,
wherein the first subcomponent is configured to create and execute a second prompt chain comprising the fourth prompt and the fifth prompt,
wherein the fourth prompt comprises a fourth instruction, the document, and the target,
wherein the large language model is configured to propose the second composition with reference to the document in accordance with a procedure included in the fourth instruction,
wherein the second composition is a composition described in the document,
wherein the second composition is relevant to the target,
wherein the fifth prompt comprises a fifth instruction and the second composition, and
wherein the large language model is configured to generate the comparative example on the basis of the second composition in accordance with a procedure included in the fifth instruction.

5. The information processing system according to claim 4,
wherein the first component is configured to receive an evaluation, to transmit the evaluation to the third component, and to receive and provide an embodiment,
wherein the evaluation is an evaluation result of an effect of the first composition,
wherein the second component is configured to receive a sixth prompt and to transmit the embodiment to the third component,
wherein the large language model is configured to generate the embodiment in accordance with the sixth prompt,
wherein the third component is configured to receive and internally share the evaluation, to receive the embodiment, and to transmit the embodiment to the first component,
wherein the first subcomponent is configured to create the sixth prompt,
wherein the sixth prompt comprises a sixth instruction, the embodiment draft, and the evaluation, and
wherein large language model is configured to generate the embodiment on the basis of the embodiment draft and the evaluation in accordance with a procedure included in the sixth instruction.

6. The information processing system according to claim 5,
wherein the first component is configured to receive a title of an invention and the target to transmit the title of the invention and the target to the third component, and to receive and provide the document,
wherein the second component is configured to receive a seventh prompt and to transmit the document to the third component,
wherein the large language model is configured to select the document from a search result in accordance with the seventh prompt,
wherein the third component is configured to receive and internally share the title of the invention and the target, to receive the document, and to transmit the document to the first component,
wherein the third component comprises a second subcomponent,
wherein the second subcomponent comprises a database and a management system,
wherein the database stores technical literature,
wherein the management system is configured to generate the search result in accordance with a query,
wherein the first subcomponent is configured to create the query and the seventh prompt,
wherein the query comprises a request to collect literature relevant to the title of the invention and the target from the database as the search result,
wherein the seventh prompt comprises a seventh instruction, the search result, and the target, and
wherein the large language model is configured to select an appropriate document relevant to the target on the basis of the search result in accordance with a procedure included in the seventh instruction.

7. An information processing method comprising a first step, a second step, a third step, a fourth step, a fifth step, a sixth step, a seventh step, an eighth step, a ninth step, a tenth step, and an eleventh step,
wherein in the first step, a first component receives a document and a target and transmits the document and the target to a second component,
wherein the document comprises technical information relevant to the target,
wherein in the second step, the second component receives and internally shares the document and the target,
wherein the second component comprises a first subcomponent configured to create and execute a first prompt chain comprising a first prompt and a second prompt,
wherein in the third step, the second component transmits the first prompt comprising a first instruction, the document, and the target to a third component,
wherein a large language model is configured to propose a first composition with reference to the document in accordance with a procedure included in the first instruction,
wherein the first composition is relevant to the target and is a composition that is not described in the document,
wherein in the fourth step, the third component receives the first prompt and generates the first composition using the large language model,
wherein in the fifth step, the third component transmits the first composition to the second component,
wherein in the sixth step, the second component receives and internally shares the first composition,
wherein in the seventh step, the second component transmits the second prompt to the third component,
wherein the second prompt comprises a second instruction and the first composition,
wherein the large language model is configured to generate an embodiment draft on the basis of the first composition in accordance with a procedure included in the second instruction,
wherein in the eighth step, the third component receives the second prompt and generates the embodiment draft using the large language model,
wherein in the ninth step, the third component transmits the embodiment draft to the second component,
wherein in the tenth step, the second component receives the embodiment draft and transmits the embodiment draft to the first component, and
wherein in the eleventh step, the first component receives the embodiment draft and provides the embodiment draft.

8. The information processing method according to claim 7, further comprising a twelfth step, a thirteenth step, a fourteenth step, a fifteenth step, a sixteenth step, a seventeenth step, and an eighteenth step,
wherein in the twelfth step, the first component receives an adjustment request and transmits the adjustment request to the second component,
wherein in the thirteenth step, the second component receives and internally shares the adjustment request,
wherein the first subcomponent is configured to create a third prompt,
wherein in the fourteenth step, the second component transmits the third prompt to the third component,
wherein the third prompt comprises a third instruction, the embodiment draft, and the adjustment request,
wherein the large language model is configured to adjust the embodiment draft on the basis of the adjustment request in accordance with a procedure included in the third instruction,
wherein in the fifteenth step, the third component receives the third prompt and adjusts the embodiment draft using the large language model,
wherein in the sixteenth step, the third component transmits the adjusted embodiment draft to the second component,
wherein in the seventeenth step, the second component transmits the adjusted embodiment draft to the first component, and
wherein in the eighteenth step, the first component receives the adjusted embodiment draft and provides the adjusted embodiment draft.

9. The information processing method according to claim 7, further comprising a nineteenth step, a twentieth step, a twenty-first step, a twenty-second step, a twenty-third step, a twenty-fourth step, and a twenty-fifth step,
wherein in the nineteenth step, the first component receives an evaluation and transmits the evaluation to the second component,
wherein in the twentieth step, the second component receives and internally shares the evaluation,
wherein the first subcomponent is configured to create a fourth prompt,
wherein in the twenty-first step, the second component transmits the fourth prompt to the third component,
wherein the fourth prompt comprises a fourth instruction, the embodiment draft, and the evaluation,
wherein the large language model is configured to generate an embodiment on the basis of the embodiment draft and the evaluation in accordance with a procedure included in the fourth instruction,
wherein in the twenty-second step, the third component receives the fourth prompt and generates the embodiment using the large language model,
wherein in the twenty-third step, the third component transmits the embodiment to the second component,
wherein in the twenty-fourth step, the second component receives the embodiment and transmits the embodiment to the first component, and
wherein in the twenty-fifth step, the first component receives the embodiment and provides the embodiment.

10. The information processing method according to claim 7, further comprising a twenty-sixth step, a twenty-seventh step, a twenty-eighth step, a twenty-ninth step, a thirtieth step, a thirty-first step, a thirty-second step, a thirty-third step, and a thirty-fourth step,
wherein the first subcomponent is configured to create and execute a second prompt chain comprising a fifth prompt and a sixth prompt,
wherein in the twenty-sixth step, the second component transmits the fifth prompt comprising a fifth instruction, the document, and the target to the third component,
wherein the large language model is configured to propose a second composition with reference to the document in accordance with a procedure included in the fifth instruction,
wherein the second composition is relevant to the target and is a composition described in the document,
wherein in the twenty-seventh step, the third component receives the fifth prompt and generates the second composition using the large language model,
wherein in the twenty-eighth step, the third component transmits the second composition to the second component,
wherein in the twenty-ninth step, the second component receives and internally shares the second composition,
wherein in the thirtieth step, the second component transmits the sixth prompt to the third component,
wherein the sixth prompt comprises a sixth instruction and the second composition,
wherein the large language model is configured to generate a comparative example on the basis of the second composition in accordance with a procedure included in the sixth instruction,
wherein in the thirty-first step, the third component receives the sixth prompt and generates the comparative example using the large language model,
wherein in the thirty-second step, the third component transmits the comparative example to the second component,
wherein in the thirty-third step, the second component receives the comparative example and transmits the comparative example to the first component, and
wherein in the thirty-fourth step, the first component receives the comparative example and provides the comparative example.

11. The information processing method according to claim 7, further comprising a first pre-processing step, a second pre-processing step, a third pre-processing step, a fourth pre-processing step, a fifth pre-processing step, a sixth pre-processing step, a seventh pre-processing step, an eighth pre-processing step, a ninth pre-processing step, and a tenth pre-processing step,
wherein in the first pre-processing step, the first component receives a title of an invention and the target and transmits the title of the invention and the target to the second component,
wherein in the second pre-processing step, the second component receives and internally shares the title of the invention and the target,
wherein a second subcomponent included in the second component comprises a database and a management system,
wherein the database stores technical literature,
wherein in the third pre-processing step, the first subcomponent creates a query,
wherein the query comprises a request to collect literature relevant to the title of the invention and the target from the database as a search result,
wherein in the fourth pre-processing step, the management system generates the search result in accordance with the query,
wherein in the fifth pre-processing step, the first subcomponent creates a seventh prompt comprising a seventh instruction, the search result, and the target,
wherein the large language model is configured to select an appropriate document relevant to the target on the basis of the search result in accordance with a procedure included in the seventh instruction,
wherein in the sixth pre-processing step, the second component transmits the seventh prompt to the third component,
wherein in the seventh pre-processing step, the third component receives the seventh prompt and generates the document using the large language model,
wherein in the eighth pre-processing step, the third component transmits the document to the second component,
wherein in the ninth pre-processing step, the second component receives the document and transmits the document to the first component, and
wherein in the tenth pre-processing step, the first component receives the document and executes the first step.
